(19) United States
(12) Patent Application Publication
(10) Pub. No.: US 2026/0332712 A1
(43) Pub. Date: Oct. 22, 2026

(54) IMAGE READING APPARATUS AND DISPLAY CONTROL METHOD FOR IMAGE READING APPARATUS

(71) Applicant: SEIKO EPSON CORPORATION, TOKYO (JP)

(72) Inventors: Noriyuki KOYANAGI, Kitakyushu-shi (JP); Rei TSUTSUI, Kitakyushu-shi (JP); Tsuneo KASAI, Azumino-Shi (JP); Masatomo KANAMITSU, Kitakyushu-Shi (JP)

(21) Appl. No.: 19/464,963

(22) Filed: Jan. 30, 2026

(30) Foreign Application Priority Data
Jan. 30, 2025 (JP) 2025-013745

(51) Int. Cl. H04N 1/00

(52) U.S. Cl. CPC H04N 1/00824; H04N 1/0049; H04N 1/00689; H04N 1/00737; H04N 1/00782; H04N 1/00814

(57) ABSTRACT

An image reading apparatus includes a document table, a document cover, a reading unit, a light emitting unit, and a control unit. The document table has a placement surface on which a document is to be placed. The document cover opens and closes the placement surface of the document table. The reading unit reads a document placed on the placement surface of the document table on an opposite side from the placement surface. The light emitting unit is configured to be switchable between turning-on and turning-off. When reading of the document is performed in an open state in which the document cover is opened with respect to the document table, the control unit turns on the light emitting unit at a predetermined position of the placement surface before the document is placed on the placement surface of the document table in the open state.

The present application is based on, and claims priority from JP Application Serial Number 2025-013745, filed Jan. 30, 2025, the disclosure of which is hereby incorporated by reference herein in its entirety.

### BACKGROUND

### 1. Technical Field

The present disclosure relates to an image reading apparatus including a reading unit that reads a document and a display control method of the image reading apparatus.

### 2. Related Art

For example, U.S. Patent Application Publication No. 2021/0084179 discloses an image reading apparatus capable of detecting that a document is placed at a predetermined position on a document table. The image reading apparatus includes a document table having a placement surface on which a document is to be placed, a document cover capable of opening and closing a placement surface of the document table, and a reading unit that reads the document.

In the technique of U.S. Patent Application Publication No. 2021/0084179, it is described that when a predetermined standby time elapses after a sensor detects that a document is placed at a predetermined position on a document table, a reading unit starts a document reading process. The document may be detected by a reading unit that reads the document.

U.S. Patent Application Publication No. 2021/0084179 is an example of the related art.

However, there is room for improvement in convenience for a user who desires to read a document in an open state in which the document cover is opened. For example, in the case of a configuration in which it is detected that a document is placed on a placement surface of the document table, the user needs to place the document at a predetermined detection position, but there is a possibility that the user may unknowingly place the document at an inappropriate position on the placement surface. In addition, the user may desire to confirm whether the document cover is in a predetermined mode for reading a document in an open state. As described above, there is room for improvement in order to improve convenience when a user who desires to perform reading of a document in a state in which the document cover is in the open state smoothly performs an operation of reading the document.

### SUMMARY

According to an aspect of the present disclosure, there is provided an image reading apparatus including a document table having a placement surface on which a document is to be placed; a document cover configured to open and close the placement surface of the document table; a reading unit configured to read a document placed on the placement surface of the document table on an opposite side from the placement surface; a light emitting unit configured to be switchable between turning-on and turning-off; and a control unit. When reading of a document is performed in an open state in which the document cover is opened with respect to the document table, the control unit turns on the light emitting unit at a predetermined position of the placement surface of the document table before the document is placed on the placement surface of the document table in the open state.

According to an aspect of the present disclosure, there is provided an image reading apparatus including: a document table having a placement surface on which a document is to be placed; a document cover configured to open and close the placement surface with respect to the document table; a reading unit configured to read a document placed on the placement surface of the document table on an opposite side from the placement surface; and a control unit. In a mode in which reading of a document is performed in an open state in which the document cover is opened with respect to the document table, the control unit executes a document reading process of causing the reading unit to read the document based on an elapse of a predetermined time from a time point when a start of a reading job is instructed by a user, the document cover is in the open state, and the document is placed on the document table.

According to another aspect of the present disclosure, there is provided a display control method for an image reading apparatus including a document table having a placement surface on which a document is to be placed, a document cover configured to open and close the placement surface with respect to the document table, a reading unit configured to read a document placed on the placement surface of the document table on an opposite side from the placement surface, and a display unit configured to display information, the display control method of the image reading apparatus includes: when an instruction is given to perform reading of the document in an open state in which the document cover is opened with respect to the document table, displaying, by the display unit, guidance information for guiding a placement position on the placement surface of the document table, the placement position being a position on which the document is to be placed.

### BRIEF DESCRIPTION OF THE DRAWINGS

FIG. 1 is a schematic front cross-sectional view illustrating an image reading apparatus according to an embodiment.

FIG. 2 is a schematic perspective view illustrating the image reading apparatus in which a document cover is in an open state.

FIG. 3 is a partially cutaway schematic front view of the image reading apparatus on which a book is placed as a document.

FIG. 4 is a schematic plan view illustrating a configuration of a reading module.

FIG. 5 is a block diagram illustrating an electrical configuration of the image reading apparatus.

FIG. 6 is a schematic view illustrating a selection screen for a document standby mode.

FIG. 7 is a schematic view illustrating a first setting screen for setting a standby time.

FIG. 8 is a schematic view illustrating a second setting screen for setting the standby time.

FIG. 9 is a flowchart illustrating a book scan processing routine.

FIG. 10 is a schematic view illustrating a guidance screen for prompting an opening operation of the document cover.

FIG. 11 is a schematic view illustrating a guidance screen for guiding placement of a document.

FIG. 12 is a schematic plan view illustrating the image reading apparatus before the document is placed.

FIG. 13 is a schematic plan view illustrating the image reading apparatus when a document is placed.

FIG. 14 is a diagram of a document detection process performed in a state in which the document cover is in the open state, and is a schematic view of an image reading apparatus on which a book is placed and a graph illustrating read data of a reading unit.

FIG. 15 is a schematic view illustrating the notification screen for notifying that scanning is in progress.

FIG. 16 is a schematic view illustrating a guidance screen for guiding removal of the document.

FIG. 17 is a schematic view illustrating a guidance screen for guiding placement of a document.

FIG. 18 is a schematic plan view illustrating an image reading apparatus including a sensor according to a modification.

FIG. 19 is a schematic plan view illustrating a sensor.

### DESCRIPTION OF EMBODIMENTS

Hereinafter, an embodiment of an image reading apparatus will be described with reference to the drawings.

### Configuration of Image Reading Apparatus

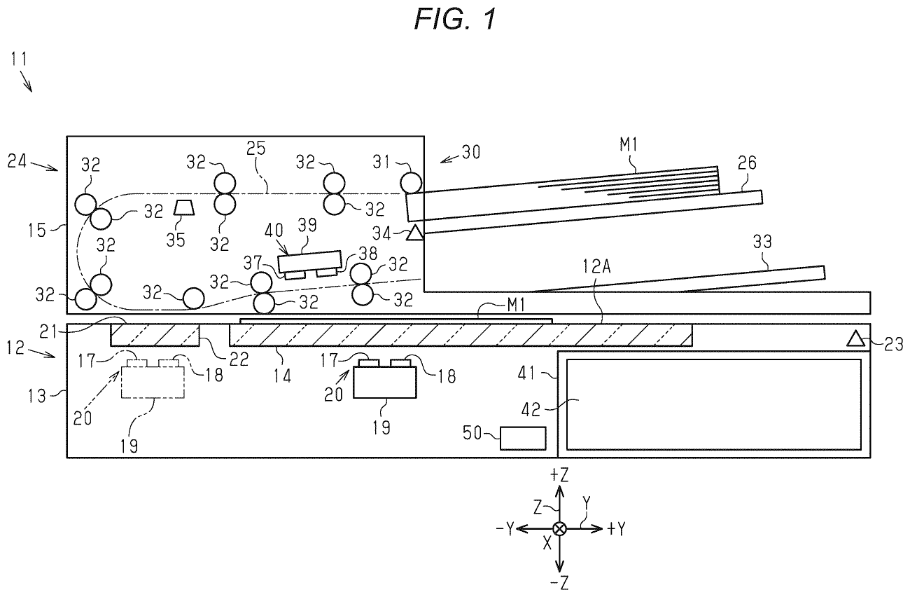

FIG. 1 illustrates an image reading apparatus 11 that is in a posture in a use state. XYZ axes illustrated in FIG. 1 are orthogonal to one another. The Z axis is an axis parallel to the direction of gravity. The Y axis is an axis parallel to a width direction of the image reading apparatus 11 when viewed from the front illustrated in FIG. 1. The X axis is an axis parallel to a depth direction of the image reading apparatus 11. Directions parallel to the X axis, the Y axis, and the Z axis are respectively represented as an X direction, a Y direction, and a Z direction. The X direction includes both of a +X direction and a-X direction. The Y direction includes both of a +Y direction and a −Y direction. The Z direction includes both of a +Z direction and a −Z direction. The Y direction is also referred to as width direction Y, the X direction is also referred to as depth direction X, and the Z direction is also referred to as vertical direction Z.

As illustrated in FIG. 1, the image reading apparatus 11 includes a document table 12 and a document cover 15. The document table 12 has a placement surface 12A on which a document M1 is placed. The document M1 is set on the document table 12 by being placed on the placement surface 12A.

The document table 12 includes a housing 13 and a transparent plate 14. The transparent plate 14 is attached to an upper part of the housing 13. The transparent plate 14 forms a top plate of the housing 13. The document table 12 has translucency. That is, the document table 12 has translucency at a portion of the transparent plate 14. The upper surface of the transparent plate 14 forms the placement surface 12A. The document table 12 has translucency on the placement surface 12A. The upper surface of a portion where the transparent plate 14 is exposed on the upper surface of the document table 12 is the placement surface 12A. The placement surface 12A has a size for enabling the document M1 having the largest size readable by the image reading apparatus 11 to be placed.

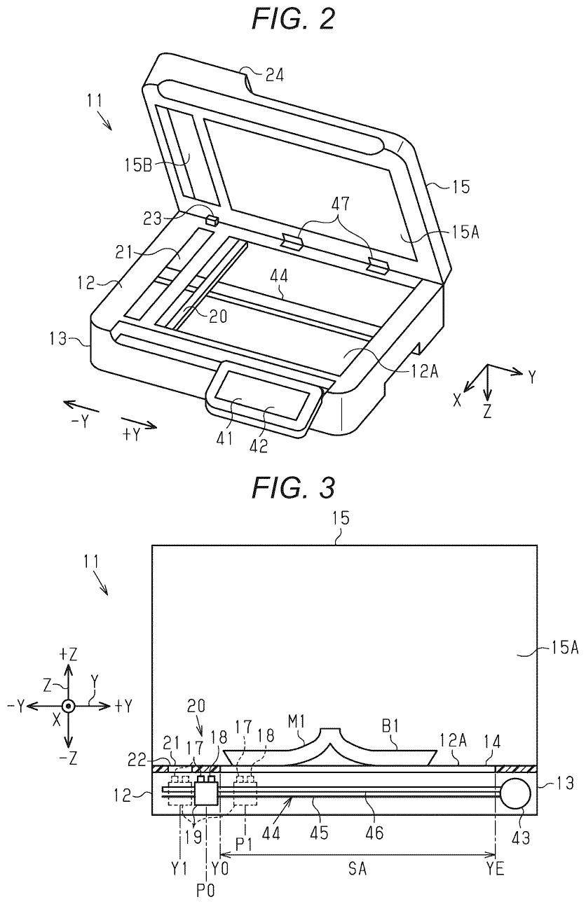

The document cover 15 opens and closes the placement surface 12A of the document table 12. The document cover 15 is implemented to be pivotable with respect to the document table 12. The document cover 15 is attached to the document table 12 via a hinge mechanism 47 (see FIG. 2). In the front view illustrated in FIG. 1, a pivot axis of the document cover 15 extends in the width direction Y at a position on a back side in the depth direction X. The document cover 15 can be opened and closed within a range of a predetermined angle centering on the pivot axis on the back side.

When the document cover 15 is opened with respect to the document table 12, the placement surface 12A, which is the upper surface of the transparent plate 14, is exposed. Accordingly, a user can place (set) the document M1 on the placement surface 12A. The document cover 15 presses the document M1 placed on the placement surface 12A from above by being closed with respect to the document table 12. In the closed state illustrated in FIG. 1, the document M1 placed on the placement surface 12A is pressed against the placement surface 12A by the document cover 15 in the closed state. In a normal mode, the document M1 is read by the image reading apparatus 11 in this pressed state. The image reading apparatus 11 according to the present embodiment has a book scan mode, which is an example of a mode in which reading of the document M1 is executed in an open state in which the document cover 15 is opened. The book scan mode will be described later.

The image reading apparatus 11 includes a reading unit 17 and a light emitting unit 18. The reading unit 17 is implemented to read the document M1 placed on the placement surface 12A. The reading unit 17 reads, on the side opposite to the placement surface 12A, the document M1 placed on the placement surface 12A of the document table 12. The reading unit 17 is located in the housing 13 of the document table 12. The reading unit 17 is located on the side opposite to the placement surface 12A with the transparent plate 14 interposed therebetween. The reading unit 17 is implemented to scan in the housing 13.

As illustrated in FIG. 1, the image reading apparatus 11 may include a carriage 19 that supports the reading unit 17 and the light emitting unit 18. The carriage 19 that supports the reading unit 17 is implemented to be movable in the width direction Y. The reading unit 17 is implemented to move in the width direction Y, together with the carriage 19, in a state of facing the placement surface 12A on the transparent plate 14 and along the placement surface 12A. The reading unit 17 scans the document M1 placed on the placement surface 12A to thereby read the document M1 through the transparent plate 14. The reading unit 17 is movable over a range wider than the placement surface 12A in the width direction Y.

The reading unit 17 includes, for example, a line sensor having an elongated shape in one direction. In the example illustrated in FIG. 1, the reading unit 17 is disposed in a direction in which the longitudinal direction thereof is parallel to the depth direction X. The longitudinal direction of the reading unit 17 is referred to as a main scanning direction, and a moving direction of the reading unit 17 is referred to as a sub scanning direction. Since the main scanning direction is a direction parallel to the depth direction X, the main scanning direction is also referred to as a “main scanning direction X”. Since the sub scanning direction is a direction parallel to the width direction Y, the sub scanning direction is also referred to as “sub scanning direction Y”. The main scanning direction X and the sub scanning direction Y intersect (for example, are orthogonal to) each other. The reading unit 17 is movable in a first direction +Y and a second direction −Y in the sub scanning direction Y by the movement of the carriage 19.

The light emitting unit 18 is capable of switching turning-on and turning-off. The light emitting unit 18 is located in the housing 13 of the document table 12. The light emitting unit 18 is provided on a side opposite to the placement surface 12A of the document table 12. The light emitting unit 18 can emit light to the outside of the placement surface 12A from the side opposite to the document table 12. The light emitting unit 18 illuminates the document M1 by being turned on when the reading unit 17 reads the document M1. The light emitting unit 18 illuminates the document M1 from an opposite side from the placement surface 12A of the document table 12 in a turn-on state. The light emitting unit 18 illuminates a reading target region to be read by the reading unit 17 on a reading surface of the document M1 placed on the placement surface 12A.

The light emitting unit 18 is implemented to scan in the housing 13. The light emitting unit 18 illuminates, through the transparent plate 14, the document M1 placed on the placement surface 12A of the document table 12. The light emitting unit 18 is supported by an upper part of the carriage 19 to move along the placement surface 12A of the document table 12 together with the reading unit 17. The light emitting unit 18 moves in the sub scanning direction Y when the carriage 19 moves. The reading unit 17 and the light emitting unit 18 are supported by the carriage 19 in a state of satisfying a positional relationship in which the light emitting unit 18 can illuminate the reading target region of the reading unit 17. The light emitting unit 18 illuminates the reading target region which is a region extending along the main scanning direction X of the reading unit 17 by being turned on.

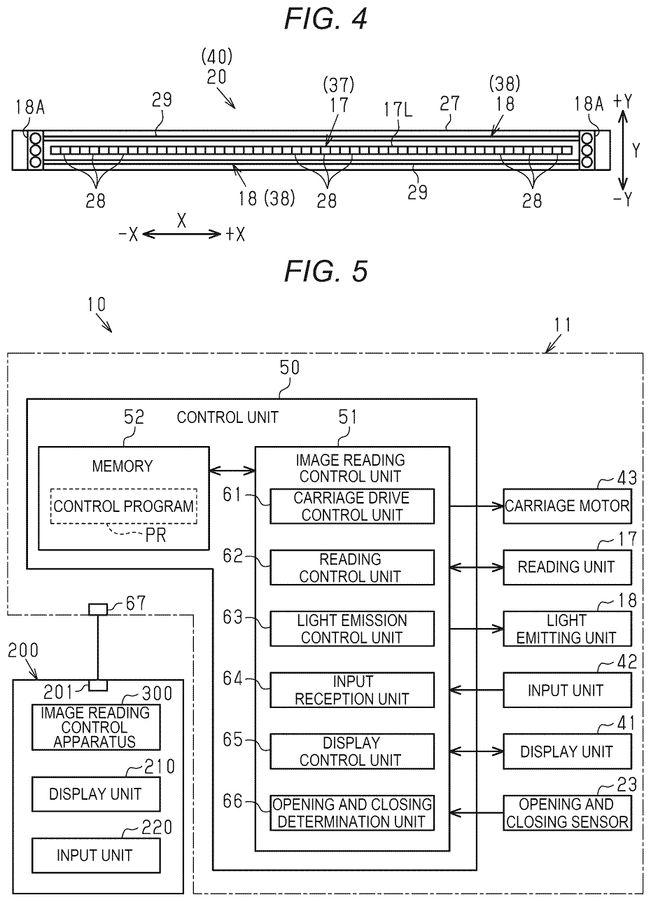

The reading unit 17 and the light emitting unit 18 constitute a reading module 20 (see FIG. 4 as well). The reading module 20 is supported by an upper part of the carriage 19. The reading unit 17 constitutes, for example, a contact image sensor (CIS). The reading module 20 according to the present embodiment is a contact image sensor module (CISM) of a CIS type (contact optical type). A detailed configuration of the reading module 20 will be described later.

The image reading apparatus 11 may include a reading window portion 21. The reading window portion 21 may be located outside the placement surface 12A in a plan view (see FIG. 2 as well). In the example illustrated in FIG. 1, the reading window portion 21 is located outside the placement surface 12A in the sub scanning direction Y. The reading window portion 21 may be provided at a position that the reading unit 17 can face. The reading window portion 21 is disposed at a position adjacent to the transparent plate 14 in the sub scanning direction Y in an upper part of the document table 12. The reading window portion 21 and the transparent plate 14 are respectively attached to positions that are both in a parallel state with and at substantially the same height as the upper part of the housing 13.

The reading unit 17 is implemented to be movable to a position illustrated by a two-dot chain line in FIG. 1, facing the reading window portion 21, by the movement of the carriage 19. The carriage 19 is movable in the sub scanning direction Y over a movement range including a position where the reading unit 17 faces the reading window portion 21 and a region where the reading unit 17 faces the placement surface 12A. Accordingly, the reading unit 17 can read the document M1 being transported at a position facing the reading window portion 21 and can read the document M1 on the placement surface 12A.

The reading window portion 21 includes a small-sized transparent plate 22 that is sufficiently smaller than the transparent plate 14. The transparent plates 14 and 22 are made of, for example, glass. The transparent plate 14 is made of large glass larger than the transparent plate 22 made of small glass constituting the reading window portion 21. Positions and lengths of the transparent plate 14 and the reading window portion 21 in the main scanning direction X are substantially the same.

The image reading apparatus 11 may include an opening and closing sensor 23. The opening and closing sensor 23 detects opening and closing of the document cover 15. The opening and closing sensor 23 is implemented to be capable of detecting an open state and a closed state of the document cover 15. The opening and closing sensor 23 may detect that the document cover 15 is open with respect to the document table 12 or may detect that the document cover 15 is closed with respect to the document table 12. The opening and closing sensor 23 is attached to, for example, the housing 13 of the document table 12 but may be attached to the document cover 15. The opening and closing sensor 23 may be a contact sensor or a non-contact sensor such as an optical sensor. For example, in the closed state of the document cover 15, the opening and closing sensor 23 may be provided at a position on the back side near the pivot axis of the document cover 15 in the depth direction X of the image reading apparatus 11, or may be provided at a position on a pivot end side of the document cover 15.

The opening and closing sensor 23 may detect an open state at the time when an opening angle, which is an angle formed by the document cover 15 with respect to the placement surface 12A, is equal to or larger than a predetermined angle and a closed state at the time when the opening angle is smaller than the predetermined angle. The predetermined angle is a predetermined value within a range from 0 degrees, which is an angle at the time when the document cover 15 is completely closed with respect to the document table 12, to a largest opening angle. The predetermined angle can be set to an appropriate value and, as an example, may be a predetermined value within a range of 1 degree or more and 30 degrees or less. In the present embodiment, the predetermined angle may be, for example, a predetermined value within a range of 2 degrees or more and 20 degrees or less.

The image reading apparatus 11 includes a display unit 41 that displays information. The display unit 41 is implemented to display a screen. The display unit 41 is, for example, a liquid crystal display. The display unit 41 is attached to, for example, the document table 12. The display unit 41 notifies information related to the image reading apparatus 11 to the user by displaying information on the screen.

The image reading apparatus 11 includes an input unit 42. The input unit 42 is operated by the user. The user gives an instruction or necessary input information to the image reading apparatus 11 through the input unit 42. The input unit 42 includes, for example, a touch panel. That is, the input unit 42 may be implemented by a touch operation function of the touch panel of the display unit 41. The input unit 42 may include at least one operation button or the like displayed on the screen of the display unit 41. The user gives an instruction or necessary input information to the image reading apparatus 11 by performing a touch operation on the screen of the display unit 41. The input unit 42 is not limited to the touch panel and may include a button, a lever, or a switch.

The image reading apparatus 11 includes a control unit 50. The control unit 50 is implemented to control the image reading apparatus 11. The control unit 50 controls the reading unit 17 and the light emitting unit 18. The control unit 50 controls the movement of the carriage 19 along the placement surface 12A. The control unit 50 controls the display unit 41. The control unit 50 causes the display unit 41 to display various information. The control unit 50 controls the image reading apparatus 11 based on an instruction given to the image reading apparatus 11 by the user through operation of the input unit 42.

The image reading apparatus 11 includes an image reading function of a flatbed type (FB type) described above and an image reading function of an automatic document feeder type (ADF type) described below. Hereinafter, a configuration of the image reading function of the ADF type will be described with reference to FIG. 1.

Configuration of Image Reading Apparatus of ADF Type

The image reading apparatus 11 illustrated in FIG. 1 includes an automatic document feeder 24. The automatic document feeder 24 is implemented to automatically feed the document M1. The automatic document feeder 24 is attached to the document cover 15. The automatic document feeder 24 feeds the document M1 into the document cover 15. A transport path 25 is formed in the document cover 15. The transport path 25 is a path on which the document M1 is transported. The transport path 25 extends in the document cover 15. The document M1 is read by the image reading apparatus 11 in a process of being transported on the transport path 25.

The automatic document feeder 24 includes a supply tray 26. The supply tray 26 is attached to the document cover 15. The supply tray 26 extends from the document cover 15. The supply tray 26 is implemented such that the document M1 is set thereon. The document M1 is placed on the supply tray 26, whereby the document M1 is set on the supply tray 26.

The automatic document feeder 24 includes a transport unit 30. The transport unit 30 is attached to the document cover 15. The transport unit 30 is implemented to transport the document M1. The transport unit 30 transports, along the transport path 25, the document M1 set on the supply tray 26. The transport unit 30 includes one or more (a plurality in the example illustrated in FIG. 1) rollers. The transport unit 30 includes, for example, a pickup roller 31 and one or more transport rollers 32. The pickup roller 31 transports a plurality of documents M1 set on the supply tray 26 one by one. In an example, the pickup roller 31 comes into contact with an uppermost document M1 among the plurality of documents M1 stacked on the supply tray 26, and transports the documents M1 in order starting from the uppermost document M1. The plurality of transport rollers 32 are located along the transport path 25. The plurality of transport rollers 32 transport the document M1 along the transport path 25.

The automatic document feeder 24 includes a discharge tray 33. The discharge tray 33 is implemented to receive the document M1 discharged from the document cover 15. The discharge tray 33 is attached to the document cover 15. The discharge tray 33 receives the read document M1.

The automatic document feeder 24 includes a detection unit 34 that detects the presence or absence of the document M1 set on the supply tray 26. The detection unit 34 may be a contact sensor or a non-contact sensor such as an optical sensor. When the opening and closing sensor 23 detects the closed state of the document cover 15 and the detection unit 34 detects the document M1 placed on the supply tray 26, the control unit 50 prioritizes the reading of the ADF type.

The automatic document feeder 24 may include a double-feeding detection unit 35 that detects double-feeding of the document M1. The double-feeding detection unit 35 detects whether the plurality of documents M1 are transported from the supply tray 26 while overlapping. The double-feeding detection unit 35 may include an ultrasonic sensor. The double-feeding detection unit 35 detects double-feeding, for example, when an attenuation rate of ultrasound transmitted through the document M1 exceeds a threshold.

The image reading apparatus 11 includes a reading unit 37 and a light emitting unit 38. The reading unit 37 and the light emitting unit 38 are supported by a support unit 39. The reading unit 37 and the light emitting unit 38 constitute a reading module 40. The support unit 39 supports the reading module 40 in a posture capable of reading the document M1 transported along the transport path 25. A configuration of the reading module 40 is basically the same as the configuration of the reading module 20 in the document table 12. The transport unit 30, the second reading unit 37, and the light emitting unit 38, which constitute the image reading mechanism of the ADF type, are controlled by the control unit 50.

The reading unit 37 is disposed at a position along the transport path 25 in the document cover 15. The reading unit 37 reads the document M1 transported from the supply tray 26. That is, the reading unit 37 reads the document M1 transported along the transport path 25.

The light emitting unit 38 is capable of switching turning-on and turning-off. The light emitting unit 38 is disposed at a position along the transport path 25. In a turn-on state, the light emitting unit 38 illuminates a region including a portion to be read by the reading unit 37 in the document M1 transported along the transport path 25.

The reading unit 17 and the reading unit 37 are implemented to be capable of reading a front surface and a back surface of the document M1 transported along the transport path 25. The reading unit 17 located in the document table 12 has both of the image reading functions of the FB type and the ADF type. In the present specification, the reading unit 17 in the document table 12 is also referred to as “first reading unit 17” and the reading unit 37 in the automatic document feeder 24 is also referred to as “second reading unit 37”.

The first reading unit 17 reads, through the reading window portion 21, a first surface of the document M1 transported along the transport path 25. At this time, the first reading unit 17 does not scan the document M1. The first reading unit 17 reads the first surface of the document M1 through the reading window portion 21 in a state of being located at a window position facing the reading window portion 21. The first surface of the document M1 is, for example, the front surface.

The second reading unit 37 reads a second surface of the document M1 transported along the transport path 25. The second surface of the document M1 is a surface on the side opposite to the first surface. The second surface of the document M1 is, for example, the back surface.

When one side of the document M1 transported along the transport path 25 is read, the one side of the document M1 is read by the first reading unit 17. When both sides of the document M1 transported along the transport path 25 are read, both sides of the document M1 are read by the first reading unit 17 and the second reading unit 37. That is, the first reading unit 17 reads the first surface (for example, the front surface) of the document M1 through the reading window portion 21 and the second reading unit 37 reads the second surface (for example, the back surface) of the document M1.

FIG. 2 illustrates the image reading apparatus 11 in an open state in which the document cover 15 is opened. The document cover 15 is pivotably attached to the document table 12 via the hinge mechanism 47. When reading the document M1 using the flatbed type (FB type), the user places the document M1 on the placement surface 12A with the document cover 15 in the open state. The display unit 41 is disposed, for example, on the front side of the document table 12. The user can confirm a display content of the display unit 41 or operate the input unit 42 while performing an operation of placing the document M1 on the placement surface 12A or an operation of aligning the placed document M1.

As illustrated in FIG. 2, a background plate 15A and a transport path 15B are provided on the back surface of the document cover 15. The background plate 15A is disposed at a position corresponding to the placement surface 12A, and has substantially the same shape and size as the placement surface 12A. When the document cover 15 is in the closed state, the placement surface 12A is covered by the background plate 15A. The transport path 15B is disposed at a position corresponding to the reading window portion 21. When the document cover 15 is in the closed state, the reading module 20 can read the first surface (front surface) of the document M1 passing through the transport path 15B by the transport unit 30 via the reading window portion 21. The user can select one of one side and both sides as a reading surface of the document on a setting screen (not illustrated) for setting a reading condition. When double-sided reading is designated, the reading module 20 reads the first surface (front surface) of the document M1 passing through the transport path 15B via the reading window portion 21, and the reading module 40 reads the second surface (back surface) opposite to the first surface of the document M1.

### Detailed Configuration of Flatbed Type

Next, a detailed configuration of the flatbed type image reading apparatus 11 will be described with reference to FIGS. 2 and 3. In FIGS. 2 and 3, a part of the configuration of the ADF type including the automatic document feeder 24 is omitted. The document M1 is, for example, a thick document such as a book or a booklet. FIG. 3 illustrates a state in which a book B1 in an opened state of a page to be read is placed on the placement surface 12A. That is, a state in which the user sets the book B1 on the document table 12 in order to read the page of the book B1 is illustrated.

As illustrated in FIG. 2, the document table 12 has, for example, a rectangular shape as a shape in a plan view when viewed from above. A lower surface (back surface) of the document cover 15 has a rectangular shape having substantially the same size as the upper surface of the document table 12. The upper surface of the document table 12 and the lower surface of the document cover 15 have substantially the same shape and size. In the closed state of the document cover 15 illustrated in FIG. 1, the document table 12 and the document cover 15 overlap in the vertical direction Z. That is, in the closed state of the document cover 15, the document cover 15 covers the entire upper surface including the placement surface 12A of the document table 12 and the reading window portion 21.

As illustrated in FIG. 3, for example, when the document M1 such as the book B1 is placed on the placement surface 12A of the document table 12, the document cover 15 is switched to the open state at a predetermined angle. The document M1 is set on the placement surface 12A of the transparent plate 14, for example, in a state of being close to two sides in the back side and on the left.

As illustrated in FIG. 3, the image reading apparatus 11 includes, in the housing 13 of the document table 12, a scanning mechanism 44 that causes the carriage 19 to perform scanning in the sub scanning direction Y and a carriage motor 43 that is a drive source of the carriage 19. The carriage 19 moves in the sub scanning direction Y via the scanning mechanism 44 with a driving force of the carriage motor 43.

The scanning mechanism 44 includes a guide member 45 and a power transmission mechanism 46. The guide member 45 guides the carriage 19 to be movable in the sub scanning direction Y. The power transmission mechanism 46 transmits the driving force of the carriage motor 43 to the carriage 19 as power for the carriage 19 to move in the sub scanning direction Y. When the carriage motor 43 is driven to rotate forward, the carriage 19 moves in a first direction +Y and, when the carriage motor 43 is driven to rotate backward, the carriage 19 moves in a second direction −Y, which is a direction opposite to the first direction +Y. Along with the movement of the carriage 19, the reading unit 17 and the light emitting unit 18 constituting the reading module 20 move in the sub scanning direction Y.

The position of the carriage 19 indicated by the solid line in FIG. 3 is a standby position P0. The standby position P0 is a position where the reading unit 17 faces a light blocking portion between the reading window portion 21 and the transparent plate 14. When the reading module 20 does not perform reading, the carriage 19 stands by at the standby position P0.

When the reading module 20 performs reading using the ADF type, the carriage 19 moves to a first reading position Y1 located at one end portion in the sub scanning direction Y. The first reading position Y1 is a position where the reading unit 17 faces the reading window portion 21 in the sub scanning direction Y.

When performing reading using the flatbed (FB) type, the reading unit 17 moves to a position in a document reading region SA in the sub scanning direction Y. The document reading region SA is a region corresponding to the placement surface 12A. The document reading region SA is a region in a range from a starting end Y0, which is an end on a reading start side of the placement surface 12A in the sub scanning direction Y, to a terminal end YE. The starting end Y0 is, for example, a reading start position of the reading unit 17. The reading unit 17 reads the document M1 such as the book B1 placed on the placement surface 12A by scanning the inside of the document reading region SA in the sub scanning direction Y from the standby position P0 illustrated in FIG. 3. The reading unit 17 starts reading from, for example, a reading start position Y0 in the process of scanning. The reading unit 17 reads the document M1 by receiving reflected light of light emitted from the light emitting unit 18 and reflected by the reading surface of the document M1.

### Regarding Book Scan Mode

A thick document M1 such as a book or a booklet (hereinafter, also referred to as “book or the like”) is sometimes read by the image reading apparatus 11. For example, in a state in which a page desired to be read of a book B1 (see FIG. 3) is opened, the user presses the opened page against the placement surface 12A. Since the book B1 is thick, the document cover 15 cannot be closed. When the user presses the document cover 15 to a closing side to press the opened page of the book B1 against the transparent plate 14, a force in an oblique direction is applied from the document cover 15 to the book B1. As a result, a placement position of the book B1 with respect to the placement surface 12A easily deviates. Therefore, in a state in which the document cover 15 is in the open state, the page of the book B1 pressed against the placement surface 12A by the user in the aligned state is read. When the user is forced to confirm the display content of the display unit 41 or operate the input unit 42 while holding the book B1 in which the book B1 is aligned at a predetermined position on the placement surface 12A with a hand (see FIG. 13), the user cannot concentrate on the alignment of the book B1. The user directing the line of sight to the display unit 41 or operating the input unit 42 with one hand while pressing the book B1 placed on the placement surface 12A with the other hand is likely to hinder a positioning work of the book B1. For example, since the user presses the book B1 while positioning the book B1, when the user is forced to perform an operation to start scanning, the user needs to perform an operation with the line of sight directed toward the input unit 42, and thus the position of the book B1 is likely to be deviated during the operation.

Therefore, the image reading apparatus 11 according to the present embodiment has a book scan mode which is a mode in which scanning is automatically started when it is detected that the document M1 such as the book B1 is placed on the placement surface 12A. In the book scan mode, when an operation of starting reading (job start operation) is performed first, and then the document M1 is detected in a document detection process of detecting that the document M1 is placed on the placement surface 12A, reading of the document M1 is automatically started.

In the present embodiment, the document M1 assumed to be read the book scan mode is a booklet such as the book B1. The booklet refers to a book in which a plurality of sheets are bound. The booklet includes the book B1 that is a thick non-periodic publication having a predetermined number of pages or more in the body text. The “booklet” includes a thin pamphlet or booklet whose body text has fewer than a predetermined number of pages, a leaflet which is a printed matter obtained by folding one sheet into a booklet, and the like.

### Regarding Turning-on Guidance of Light Emitting Unit 18

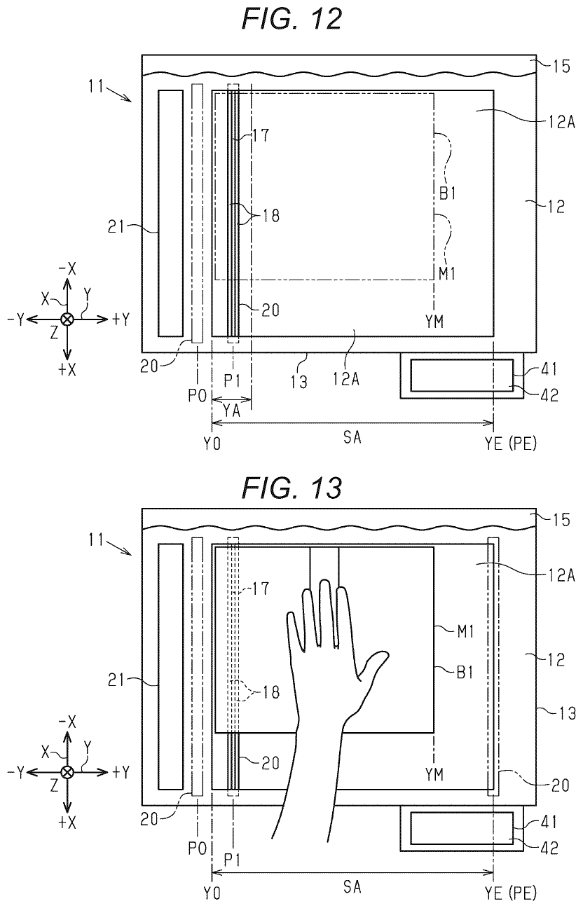

When reading the document M1 is performed in the open state in which the document cover 15 is opened with respect to the document table 12, the control unit 50 turns on the light emitting unit 18 at a predetermined position P1 (see FIGS. 3 and 12) on the placement surface 12A of the document table 12 in the open state. That is, when receiving the job start instruction in the book scan mode, the control unit 50 turns on the light emitting unit 18 at the predetermined position P1 of the placement surface 12A of the document table 12 when the document cover 15 is in the open state. Specifically, when receiving a job start instruction in the book scan mode, the control unit 50 first moves the reading module 20 to the predetermined position P1. Next, the control unit 50 turns on the light emitting unit 18 in a state in which the reading module 20 is at the predetermined position P1.

The predetermined position P1 may be a position where the turning-on of the reading module 20 can be visually recognized by the user through the transparent plate 14 forming the placement surface 12A. The predetermined position P1 may be a position within the range of the placement surface 12A in a plan view of the image reading apparatus 11 viewed in the vertical direction Z. The predetermined position P1 may be a position where a part of the light emitting unit 18 can be visually recognized in a document reading region SA in a plan view of the image reading apparatus 11.

As illustrated in FIG. 12, the predetermined position P1 may be a position within a range YA of a predetermined distance in the first direction +Y from a starting end Y0, which is an end of the placement surface 12A on the second direction −Y side (reading start position side). That is, the predetermined position P1 may be a position closer to the standby position P0 of the placement surface 12A in the sub scanning direction Y.

The turning-on of the light emitting unit 18 may indicate a placement position (document placement position) that is a position on the placement surface 12A of the document table 12 where the document M1 is placed. That is, the predetermined position P1 at which the light emitting unit 18 is turned on may be a position indicating a placement position at which the user places the book B1. Here, a distance between the transparent plate 14 and the reading module 20 in the vertical direction Z is very short. Therefore, a displacement in the sub scanning direction Y between an actual turning-on position of the light emitting unit 18 in the sub scanning direction Y and a turning-on position (apparent turning-on position) on the placement surface 12A where the user visually recognizes the turning-on of the light emitting unit 18 through the transparent plate 14 is very small. Therefore, the turning-on position of the light emitting unit 18 visually recognized by the user is substantially equal to the predetermined position P1. The user places the book B1 at the predetermined position P1 where the reading module 20 is turned on in the placement surface 12A.

The range YA to which the predetermined position P1 at which the light emitting unit 18 is turned on belongs may be, for example, a range of 3 mm or more and 50 mm or less as a distance from the starting end Y0 in the first direction +Y. When the distance is less than 3 mm, a frequency of detection omission in which the book B1 cannot be detected tends to increase due to reading of a gap between the starting end Y0 and the book B1 even though the book B1 is placed. When the distance exceeds 50 mm, a movement time of the carriage 19 from the standby position P0 to the predetermined position P1 is long, and thus a document detection delay is likely to occur. When the distance exceeds 50 mm, a time required for the reading unit 17 to move from the predetermined position P1 to the reading start position Y0 after the detection of the document is long, and thus a delay of a reading start timing of the document M1 is likely to be induced.

Further, when the distance exceeds 50 mm, a central portion of the spread of the book B1 is relatively likely to float, and thus the book B1 is likely to be detected at a position of a portion where the book B1 is likely to float. In this case, detection omission of the document M1 due to a reading target portion of the document M1 deviating from a depth of field of the reading unit 17 is likely to occur. In particular, when the reading module 20 is a CISM, since the depth of field is relatively shallow, document detection omission tends to occur easily. The range YA is not limited to the range of 3 mm or more and 50 mm or less in the first direction +Y from the starting end Y0, and a lower limit may be set to a value larger than 0 mm and less than 3 mm, or an upper limit may be set to a value larger than 50 mm. For example, the range YA may be a range of 1 mm or more and 10 mm or less in the first direction +Y from the starting end Y0. Alternatively, the range YA may be a range of 5 mm or more and 30 mm or less in the first direction +Y from the starting end Y0.

The turning-on of the light emitting unit 18 at the predetermined position P1 under the open state of the document cover 15 may be continuous turning-on or blinking. In the present embodiment, the turning-on of the light emitting unit 18 is blinking. The control unit 50 causes the light emitting unit 18 to blink to indicate the placement position. The blinking at the predetermined position P1 of the reading module 20 may have a function of guiding the user as to which position on the placement surface 12A the user is to perform an operation. The blinking of the light emitting unit 18 at the predetermined position P1 of the reading module 20 may have a function of notifying the user of the state of the image reading apparatus 11. When the blinking at the reading module 20 has a function of guiding the position, the predetermined position P1 is a position to be guided to the user. When the blinking at the reading module 20 has a function of guiding the state of the image reading apparatus 11, the predetermined position P1 may be a position where the user can visually recognize the turning-on of the light emitting unit 18 through the transparent plate 14.

The control unit 50 may cause the display unit 41 to display guidance information for guiding the placement of the document M1 at the position indicated by the turning-on of the light emitting unit 18. The control unit 50 causes the display unit 41 to display guidance information indicating that the book B1 is to be placed at the predetermined position P1, which is the position of the reading module 20 being turned on or blinking. The guidance information is, for example, a guidance image including a GUI for notifying information. In the present embodiment, the placement position of the document M1 is guided to the user by turning-on (for example, blinking) of the light emitting unit 18 at the predetermined position P1 and the guidance information displayed on the display unit 41. The user who views the guidance information displayed on the display unit 41 places the book B1 on the predetermined position P1 which is the turning-on position of the light emitting unit 18 on the placement surface 12A. That is, the user places the book B1 on the placement surface 12A to cover the predetermined position P1 where the light is turned on in the placement surface 12A. The book B1 is placed on the placement surface 12A at a position where the blinking reading module 20 can read the book B1.

In the image reading apparatus 11 in the present embodiment, the control unit 50 detects, using the reading unit 17, that the document M1 such as the book B1 to be placed on the placement surface 12A. That is, the control unit 50 detects the presence or absence of the document M1 such as the book B1 on the placement surface 12A using the reading unit 17. The control unit 50 detects that the document M1 is placed on the placement surface 12A based on a reading result when the reading unit 17 performs reading while the light emitting unit 18 is turned on. In the present embodiment in which the light emitting unit 18 blinks, the control unit 50 detects that the document M1 is placed on the placement surface 12A based on a reading result when the reading unit 17 is caused to perform reading when the light emitting unit 18 is turned on during blinking. Details of the document detection process will be described later.

### Configuration of Reading Module 20

Next, a configuration of the reading module 20 will be described with reference to FIG. 4. The two reading modules 20 and 40 have the same basic configuration. Therefore, the configuration of the reading module 20 will be described below.

The reading module 20 is, for example, a contact image sensor (CIS). The reading module 20 includes the reading unit 17 and the light emitting unit 18. The reading unit 17 and the light emitting unit 18 constituting the contact image sensor are integrated. The reading module 20 includes a long support unit 27 extending in the main scanning direction X. The reading unit 17 and the light emitting unit 18 are supported by the support unit 27 in a state in which the longitudinal direction of the reading unit 17 and the light emitting unit 18 is arranged in a direction coinciding with the main scanning direction X.

The reading unit 17 illustrated in FIG. 4 includes, for example, a line sensor 17L and an imaging lens (not illustrated). The line sensor 17L includes a plurality of image sensors 28. The plurality of image sensors 28 constituting the line sensor 17L are arranged in a row along the main scanning direction X. The image sensor 28 is a photoelectric conversion element. The image sensor 28 is equivalent to one reading pixel (one pixel) constituting the line sensor 17L. The image sensor 28 outputs a luminance signal corresponding to the amount of received incident light. The number m of the plurality of image sensors 28 is, for example, a predetermined number within a range of 500 to 10,000. An imaging lens is configured with a lens array such as a rod lens array (equal magnification imaging system lens).

The light emitting unit 18 includes light sources 18A and a light guide member 29. One light source 18A is disposed at one end portion or two light sources 18A are disposed at both end portions of the support unit 27 in the longitudinal direction. In the example illustrated in FIG. 4, two light sources 18A are disposed at both the end portions of the support unit 27 in the longitudinal direction. The light guide member 29 is supported by the support unit 27 in a state of extending in the main scanning direction X at a position on both sides or one side of the reading unit 17 in the sub scanning direction Y. In the example illustrated in FIG. 4, a pair of light guide members 29 are disposed on both sides of the reading unit 17 in the sub scanning direction Y. The light guide member 29 is, for example, a light guide. The light guide member 29 illuminates a reading target area of the reading unit 17 while guiding light from the light source 18A in the main scanning direction X when the light source 18A is turned on. The light emitting unit 18 emits uniform light in the main scanning direction X from the light guide member 29 when the light source 18A is turned on. The light source 18A may be a white light source that emits white light or may include three types of light sources capable of respectively emitting monochromatic light of red, green, and blue. The light source 18A may include, for example, a light emitting diode (LED).

### Electrical Configuration of Image Reading Apparatus 11

Next, an electrical configuration of the image reading apparatus 11 according to the present embodiment will be described with reference to FIG. 5. In FIG. 5, a part of the configuration of the ADF type image reading mechanism of the image reading apparatus 11 is omitted.

As illustrated in FIG. 5, the image reading apparatus 11 includes the control unit 50, the carriage motor 43, the reading unit 17, the light emitting unit 18, the input unit 42, the display unit 41, and the opening and closing sensor 23.

The control unit 50 may include one or more processors that execute various processes according to a computer program. The control unit 50 may include one or more dedicated hardware circuits, for example, ASICs that execute at least some processes. The control unit 50 may include a circuit including a combination of a processor and a hardware circuit. The processor includes a CPU and a memory 52 such as a RAM and a ROM. The memory 52 stores program codes or commands implemented to cause the CPU to execute processes. The memory, that is, a computer-readable medium includes any readable medium accessible by a general-purpose or dedicated computer.

The carriage motor 43, the reading unit 17, the light emitting unit 18, the input unit 42, the display unit 41, and the opening and closing sensor 23 are electrically coupled to the control unit 50. The control unit 50 controls the carriage motor 43, the reading unit 17, and the light emitting unit 18 to execute various processes related to reading of the document M1 and reading of the document M1.

The control unit 50 includes an image reading control unit 51 and the memory 52. A control program PR is stored in the memory 52. The image reading control unit 51 includes software implemented by a computer of the control unit 50 executing the control program PR and the like and hardware such as an ASIC. The image reading control unit 51 includes a carriage drive control unit 61, a reading control unit 62, a light emission control unit 63, an input reception unit 64, a display control unit 65, and an opening and closing determination unit 66.

The carriage drive control unit 61 controls the carriage motor 43. The carriage drive control unit 61 moves the carriage 19 in the sub scanning direction Y by driving the carriage motor 43 to rotate forward and backward. The control unit 50 causes, with the movement of the carriage 19, the reading unit 17 and the light emitting unit 18 to perform scanning in the sub scanning direction Y.

The reading control unit 62 controls the reading unit 17. The reading control unit 62 controls a reading process of the reading unit 17. The reading unit 17 outputs a read signal formed by an analog signal by reading the document M1. The read signal includes a serial signal having, as a signal value, each light receiving amount of the plurality of image sensors 28 constituting the reading unit 17. The reading control unit 62 generates read data by converting the read signal input from the reading unit 17 from the analog signal into a digital signal. The read data includes serial data in which each light receiving amount of the plurality of image sensors 28 at different main scanning positions is indicated by a tone value of a predetermined tone (for example, 256 tones). The read data includes a plurality of pieces of serial data corresponding to read signals read at each sub scanning position by the reading unit 17 moving in the sub scanning direction Y. The read data is, for example, data of a reading resolution designated by the reading condition. The control unit 50 generates scan data which is a reading result of the document M1 by performing a predetermined process on the read data from the reading control unit 62. The predetermined process may include an image process of at least one of rotation, background removal, shadow removal, tilt correction, and blank page removal of a document image. Further, the predetermined process may include a filing process of generating scan data by filing image data after the image process.

The user can select a desired one of a plurality of file formats on a setting screen (not illustrated) displayed on the display unit 41. The scan data is file data in a file format designated by the user on the setting screen. The plurality of file formats prepared to be selectable on the setting screen include a PDF format, a JPEG format, a TIFF format, and a BMP format. The plurality of file formats include a predetermined file format in which the image data of a plurality of pages obtained by a plurality of scans can be combined into one file. When the predetermined file format is selected, the control unit 50 executes a filing process of combining the image data of a plurality of pages into one file. The page referred to here is not a page of the book B1 but an image read once. When the document M1 is the book B1, the image data of one page corresponds to two pages of the spread of the book B1.

In the present embodiment, the predetermined file format is, for example, a PDF format. When the PDF format is designated, the control unit 50 executes a PDF conversion process of converting a plurality of pieces of image data into one PDF file. There may be two types of designation of the PDF file: PDF (multi-page) and PDF (single-page). Multi-page is a format in which a plurality of pages are combined into one file, and single-page is a format in which a file is generated for each page when a plurality of documents are read. As the predetermined file format, a file format other than the PDF format may be selectable. TIFF (multi-page) may be selected as the predetermined file format.

The control unit 50 performs a document detection process of detecting the document M1 placed on the placement surface 12A by the user. Specifically, the reading control unit 62 causes the reading unit 17 to perform reading for document detection at a predetermined position on the placement surface 12A in a document placement waiting state.

The light emission control unit 63 performs control for switching light emission and turning-off of the light emitting unit 18. The control unit 50 turns off the light emitting unit 18 in a standby state in which reading is not executed. The control unit 50 turns on the light emitting unit 18 during reading of the document M1. The control unit 50 performs the document detection process of detecting that the user places the document M1 on the placement surface 12A. The light emission control unit 63 turns on the light emitting unit 18 in the document detection process of detecting the document M1 placed on the placement surface 12A. The turning on of the light emitting unit 18 in the document detection process may be blinking.

The input reception unit 64 receives input information input by the user operating the input unit 42. The input unit 42 of the present embodiment includes, for example, a touch panel of the display unit 41. The input reception unit 64 receives the input information input via the input unit 42 (touch panel) by the user performing a touch operation on options such as selection items or buttons on the screen displayed on the display unit 41. The input reception unit 64 receives, for example, mode selection information, job start instruction information, mode end instruction information, and various types of setting information as the input information.

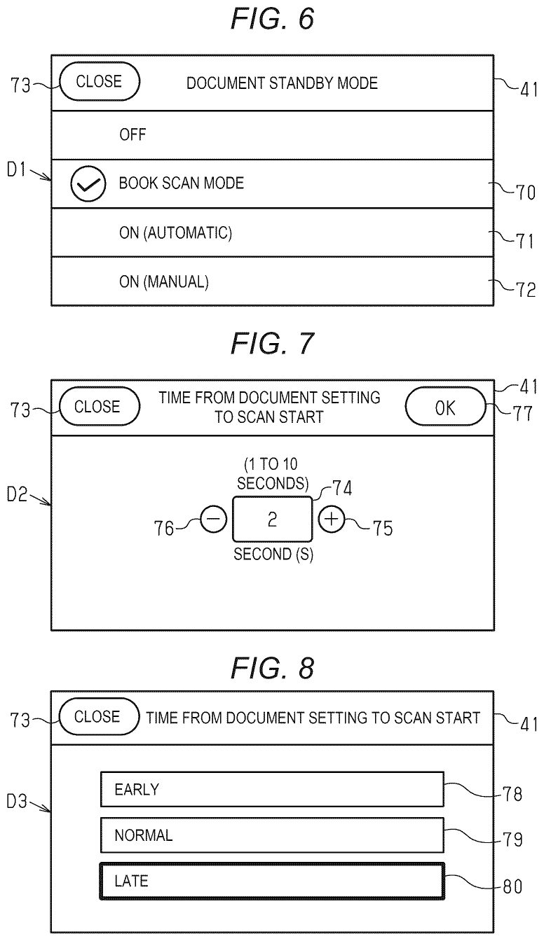

The display control unit 65 controls the display unit 41. The display control unit 65 controls the display unit 41 to display screens such as a menu screen and various setting screens on the display unit 41. The screen includes guidance information and notification information. The display control unit 65 causes the display unit 41 to display guidance information for guiding an operation or the like to be performed by the user in the book scan mode and notification information to be notified to the user through a screen displayed on the display unit 41. In a mode in which the user reads the thick document M1 such as the book B1 (book scan mode), the display control unit 65 displays guidance information for the mode on the display unit 41. For example, the display control unit 65 causes the display unit 41 to display various screens D1 to D8 illustrated in FIGS. 6 to 8, 10, 11, 15, 16, and 17. Details of the various screens D1 to D8 will be described later.

The opening and closing determination unit 66 receives an input of a detection signal from the opening and closing sensor 23. The opening and closing determination unit 66 determines, based on the detection signal input from the opening and closing sensor 23, whether the document cover 15 is in the open state or the closed state. Here, the opening and closing sensor 23 outputs a detection signal when the document cover 15 is in the closed state, and outputs a non-detection signal when the document cover 15 is in the open state. The opening and closing sensor 23 outputs the non-detection signal indicating the open state when an angle of the document cover 15 exceeds a predetermined angle larger than 0 degrees. The opening and closing sensor 23 outputs the detection signal indicating the closed state when the angle of the document cover 15 is smaller than the predetermined angle.

### Image Reading Control Apparatus (Host Apparatus)

The image reading apparatus 11 can be communicably connected to a host apparatus 200 such as a personal computer (PC). The image reading apparatus 11 and a reading control apparatus 300 constitute a reading control system 10. The image reading apparatus 11 includes a communication interface 67 capable of communicating with the host apparatus 200. The host apparatus 200 includes a communication interface 201 capable of communicating with the communication interface 67 of the image reading apparatus 11. The image reading apparatus 11 can perform wired or wireless communication with the host apparatus 200 via the communication interfaces 67 and 201. The host apparatus 200 is not limited to a PC, and may be implemented by, for example, a smartphone, a mobile phone, a tablet PC, or a mobile terminal such as personal digital assistants (PDA).

The host apparatus 200 includes a display unit 210 and an input unit 220. The display unit 210 is, for example, a liquid crystal display. The input unit 220 includes a keyboard, a pointing device such as a mouse, and the like. The host apparatus 200 includes a CPU and a memory. The memory stores a scan driver program. For example, the scan driver program is installed in the host apparatus 200 from a storage medium such as a CD-ROM or a DVD, or is downloaded to the host apparatus 200 through the Internet from a predetermined server provided by an image reading apparatus manufacturer or the like. The reading control apparatus 300 includes software constructed in the host apparatus 200 by the CPU of the host apparatus 200 executing a scan driver program. The reading control apparatus 300 includes a scan driver.

The user can give an instruction to the reading control apparatus 300 by operating the input unit 220. For example, the user can set a reading condition by pressing various buttons on the setting screen displayed on the display unit 210 by operating the input unit 220. The user can give a reading instruction (scan instruction) to the reading control apparatus 300 by pressing a job start button on the setting screen. Upon receiving the reading instruction, the reading control apparatus 300 generates a reading job based on the reading conditions. The reading control apparatus 300 transmits the generated reading job to the image reading apparatus 11.

The reading control apparatus 300 (scan driver) can cause the display unit 210 of the host apparatus 200 to display guidance information and notification information having the same contents as those of various types of guidance information and notification information displayed on the display unit 41 of the image reading apparatus 11. That is, the reading control apparatus 300 includes a GUI similar to the GUI on an image reading apparatus 11 side. By operating the input unit 220 of the host apparatus 200, the user can give various instructions related to the book scan mode to the reading control apparatus 300 by selection of the book scan mode, an operation of the job start button, an end operation of the book scan mode, a cancel operation, and the like. These operation functions related to the book scan mode may be implemented by a GUI generated by the scan driver. The user can instruct the control unit 50 of the image reading apparatus 11 to start a reading job by operating the input unit 220 of the host apparatus 200.

### Contents of Book Scan Mode and Guidance Screen

In the book scan mode, the control unit 50 causes the display unit 41 to display various types of guidance information for guiding an operation to be performed by the user and notification information for notifying the user of necessary information.

The book scan mode proceeds in the following procedure including a display step of displaying guidance information or notification information on the display unit 41, a user operation step in which the user performs an operation guided by the guidance information, and a processing step in which the reading module 20 performs a predetermined process. Hereinafter, steps (U1) to (U6) with the alphabet “U” at the head are user operation steps. Steps (G1) to (G5) with the alphabet “G” at the head are display steps in which the control unit 50 (that is, the display control unit 65) causes the display unit 41 to display information such as guidance information. Steps (S1) to (S6) with the alphabet “S” at the head are processing steps executed by the control unit 50.
(U1) An instruction to select a book scan mode and start a reading job.
(G1) Guidance information prompting an opening operation of the document cover 15 is displayed.
(U2) An opening operation is performed by a user to open the document cover 15.
(S1) An open state of the document cover 15 is detected.
(G2) Guidance information prompting an operation of placing the book B1 at a predetermined position on the placement surface 12A is displayed.
(U3) The book B1 is placed at a predetermined position on the placement surface 12A.
(S2) It is detected that the book B1 is placed at a placement position which is a predetermined position of the placement surface 12A.
(S3) A document reading process of reading the book B1 is executed.
(G3) Guidance information prompting a document removal operation of removing the book B1 from the placement surface 12A is displayed.
(U4) A document removal operation of removing the book B1 from the placement surface 12A.
(G4) Guidance information prompting an operation of changing the page to be read and placing the book B1 at the placement position on the placement surface 12A is displayed.
(G5) Guidance information guiding an end operation for ending the book scan mode is displayed.
(U5) An operation of changing the page to be read and placing the book B1 at the placement position of the placement surface 12A.
(G4), (G5), (U5), and (S2) to (U5) are repeated.
(U6) An end operation of ending the book scan mode.
(S4) It is determined whether an end condition of the book scan mode is satisfied.
(S5) The book scan mode is ended.
(S6) Image data of one or more pages obtained by reading the book B1 is converted into a PDF file.

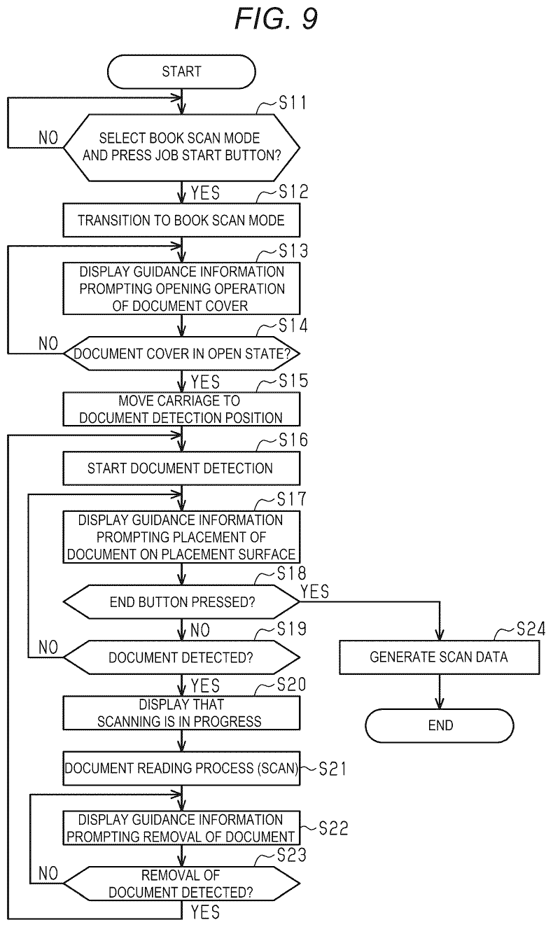

The memory 52 stores a control program PR for causing the control unit 50 to execute steps other than the user operation steps (U1) to (U6) among the steps described above. Specifically, the control program PR includes a book scan processing routine illustrated by a flowchart in FIG. 9.

In the display steps (G1) to (G5), various screens D3 to D8 illustrated in FIGS. 8, 10, 11, and 15 to 17 are displayed.

The processing step includes the document detection processing step (S2) of detecting that the book B1 is placed at a placement position which is an example of a predetermined position of the placement surface 12A, and the document reading processing step (S3) of reading the book B1 when the placement of the book B1 is detected. The processing steps include the determination processing step (S4) of determining whether an end condition of the book scan mode is satisfied, and an end process (S5) of ending the book scan mode when the end condition is satisfied. Further, the processing step further includes a filing process (S6) of generating scan data in a file format in which image data of one or more pages obtained by reading the book B1 is combined into one file. The file conversion by the filing process is, for example, PDF conversion in which a plurality of images obtained by reading one or more documents M1 are combined into one PDF file. The book scan processing routine illustrated in the flowchart of FIG. 9 includes the above-described steps.

### Regarding Book Scan Mode

The control unit 50 has a book scan mode as an example of a mode for executing reading of the document M1 in an open state in which the document cover 15 is open with respect to the document table 12. The control unit 50 has a standard scan mode as an example of a mode for executing reading of the document M1 in a closed state in which the document cover 15 is closed with respect to the document table 12. The standard scan mode is, for example, a default mode selected when scanning a document or the like printed on a single sheet. When the document is a booklet such as the book B1 and the user wants to read the book B1 in the open state of the document cover 15, the user selects the book scan mode.

FIG. 6 illustrates a selection screen D1 of a document standby mode. The document standby mode is a mode in which the image reading apparatus 11, upon detecting that the document M1 is set, automatically starts reading the document M1. The image reading apparatus 11 according to the present embodiment includes an ADF type document standby mode and an FB type document standby mode. The FB type document standby mode is a mode in which the image reading apparatus 11 automatically starts reading the document M1 when it is detected that the user places (sets) the document M1 such as the book B1 on the placement surface 12A. The FB type document standby mode corresponds to a book scan mode as an example of a mode.

As illustrated in FIG. 6, the selection screen D1 of the document standby mode includes a mode selection button 70 for selecting the book scan mode. In addition to the FB type document standby mode, an ADF type document standby mode may be provided.

The image reading apparatus 11 includes a job start button 71 that receives an instruction to start a reading job of the document M1. In the present embodiment, the job start button 71 is implemented by a graphical user interface (graphical user interface (GUI)). Specifically, the selection screen D1 including the job start button 71 is implemented by the GUI.

The selection screen D1 includes an “automatic mode” in which a reading job of the document M1 is started “automatically” and a “manual mode” in which the reading job is started manually in the book scan mode. In the automatic mode, even when a plurality of documents are read, the start of a reading job may be instructed only once. The selection screen D1 includes the job start button 71 operated by the user when instructing the start of the reading job only for the first time. The selection screen D1 includes a manual mode selection button 72 for selecting a “manual mode” in which a reading job of the document M1 (book B1) is started “manually” for each page. The control unit 50 according to the present embodiment is characterized in that, in the book scan mode in which the document M1 is read under the open state of the document cover 15, the reading job of the document M1 for each page is automatically started based on the detection of the placement of the document M1 on the placement surface 12A. For example, the user can automatically start a reading job for each of the documents M1 such as the book B1 by pressing the mode selection button 70 for selecting the book scan mode on the selection screen D1 and pressing the job start button 71. The selection screen D1 includes a close button 73 for instructing to close the screen from the display unit 41. In the present specification, “press” indicating a button operation includes a touch operation of selecting a button or the like on the screen of the display unit 41 including a touch panel.

### Start Condition for Reading Job in Book Scan Mode

The control unit 50 receives an instruction to start the reading job via the job start button 71. Further, the control unit 50 determines whether the open state is detected by the opening and closing sensor 23. The control unit 50 determines whether the placement of the document M1 on the placement surface 12A is detected. The control unit 50 causes the reading unit 17 to execute a document detection reading process at a predetermined position of the placement surface 12A in order to detect that the document M1 is placed on the placement surface 12A. The control unit 50 detects that the document is placed on the document table 12 based on a reading result of the reading unit 17. The control unit 50 executes a document reading process of reading the document M1 after a predetermined time T elapses from the detection of the placement of the document M1 on the document table 12 based on the reading result by the reading unit 17.

That is, in the book scan mode, the control unit 50 executes the document reading process of reading the document M1 (book B1) based on the elapse of the predetermined time T from the time point when the following three conditions (a1) to (c1) are satisfied.
(a1) The start of the reading job is instructed by the user.
(b1) The document cover 15 is in the open state.
(c1) The document M1 is placed on the placement surface 12A of the document table 12 (document setting).

Any of (a1) to (c1) may be performed first or later. That is, the order is not limited as long as these three conditions are satisfied.

Here, the instruction in the (a1) in the present embodiment includes selection of the book scan mode by pressing the mode selection button 70, and a job start instruction by pressing the job start button 71 in the automatic mode or pressing a job start button (not illustrated) in the manual mode.

In the book scan mode, reading of the document M1 is started when the predetermined time T elapses after all of the three conditions of (a1) to (c1) are satisfied.

In the book scan mode, a reading start trigger is partially different between the automatic mode and the manual mode. That is, when the book B1 is continuously read page by page, the reading start trigger of the first time (first page) of the book B1 is the same, but the reading start trigger of the document M1 after the second time (second page) is different.

In the automatic mode of the book scan mode, the job start instruction based on the pressing of the job start button 71 may be issued only once at the start of the book scan mode. In this respect, it can be said that the job start button 71 is an automatic mode start button of the book scan mode. The control unit 50 executes the document reading process of causing the reading unit 17 to read the document M1 based on detecting that the document M1 is placed on the placement surface 12A. When the control unit 50 detects that the document M1 is placed on the placement surface 12A in the document placement waiting state in the book scan mode, the control unit 50 executes the document reading process. After the job start instruction (automatic mode start instruction) is received, the document reading process is executed when the predetermined time T elapses every time the above-described two conditions (b1) and (c1) are satisfied. That is, after receiving the job start instruction, the control unit 50 starts reading the document M1 for each page when the predetermined time T elapses after the placement of the document M1 on the placement surface 12A is detected (condition (c1) is satisfied) under the open state of the document cover 15 (condition (b1)).

In contrast, the manual mode is a mode in which the job start instruction is issued by pressing the job start button 71 for each page from which the book B1 is read. In the manual mode, the document reading process is not started until the user presses the job start button 71. The manual mode is a mode in which the user can secure an operation required time required for placing and positioning the book B1 at his or her own pace. In the normal mode, reading of the document M1 is started for each page based on pressing of a job start button (not illustrated) in the closed state of the document cover 15.

### Regarding Setting of Predetermined Time T

FIGS. 7 and 8 are setting screens D2 and D3 for setting a standby time from document setting to the start of scanning. The control unit 50 has a setting function that allows the user to set a predetermined time as the standby time. In the present embodiment, the first setting screen D2 on which the predetermined time can be set by a numerical value and the second setting screen D3 on which the predetermined time can be set by selecting one of a plurality of options are provided. The control unit 50 causes the display unit 41 to display the setting screens D2 and D3 on which the user can set a predetermined time. One setting screen or a plurality of types of setting screens may be prepared. In the present embodiment, a plurality of types (for example, two types) of setting screens are prepared. That is, in the present embodiment, the first setting screen D2 and the second setting screen D3 are prepared as the setting screens. The first setting screen D2 is a screen on which the predetermined time can be set by a numerical value. The second setting screen D3 is a screen on which the predetermined time can be set by selecting one of a plurality of options obtained by dividing the predetermined time in stages by a length of time.

As illustrated in FIG. 7, the first setting screen D2 includes an input field 74 for inputting the number of seconds, a plus button 75 for increasing the number of seconds of the input field 74, and a minus button 76 for decreasing the number of seconds of the input field 74. Here, a value increased or decreased by one operation of each of the buttons 75 and 76 is not limited to one second, and may be every 0.5 seconds or every two seconds. In addition, when each of the buttons 75 and 76 is continuously pressed, the value may be continuously increased one by one or continuously decreased one by one over a period in which the button is continuously pressed. The first setting screen D2 includes an OK button 77 that is selected when the numerical value of the input field 74 is set as the predetermined time T. The user sets the predetermined time T by pressing the OK button 77 after setting the numerical value of the input field 74 to a desired set time. The settable number of seconds is a predetermined time within a range of 1 to 10 seconds, and the settable number of seconds may be set to an appropriate range. For example, a lower limit value of the number of seconds is not limited to 1 second, and may be a shorter number of seconds (for example, 0 second) or a longer number of seconds (for example, 2 seconds). For example, an upper limit value of the number of seconds is not limited to 10 seconds, and may be a shorter number of seconds (for example, 5 seconds) or a longer number of seconds (for example, 15 seconds).

As illustrated in FIG. 8, the second setting screen D3 is a screen on which the predetermined time can be set by selecting one option from among a plurality of options divided in stages by the length of time. The second setting screen D3 includes, as a plurality of options, three options of a first option 78 capable of selecting “early”, a second option 79 capable of selecting “normal”, and a third option 80 capable of selecting “late”. The plurality of options may be two options of “early” and “late”, or may be four or more options in which one time can be set as the predetermined time from among four or more time options.

The image reading apparatus 11 according to the present embodiment includes, for example, both the setting screens D2 and D3 of FIGS. 7 and 8. The image reading apparatus 11 may include a selection operation unit (not illustrated) that allows the user to select one of the two setting screens D2 and D3. Similarly to the setting screens D2 and D3, the selection operation unit may be implemented by a GUI that can be displayed on the display unit 41 by the control unit 50. In the image reading apparatus 11 according to the present embodiment, the predetermined time can be set in advance by the setting screens D2 and D3. The predetermined time T may be implemented to be individually set in the automatic mode and the manual mode of the book scan mode.

The memory 52 stores a control program PR including a book scan processing routine illustrated in a flowchart of FIG. 9. The book scan processing routine is a reading control processing routine dedicated to the book scan mode. The book scan processing routine includes a display control program for causing the control unit 50 to display the guidance information on the display unit 41 in the book scan mode. The control program PR includes a program related to a reading control routine (not illustrated) in the normal mode in addition to the book scan mode.

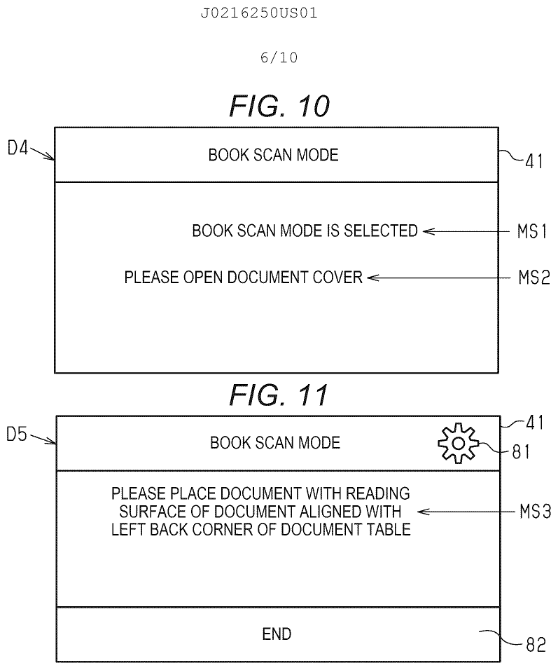

FIG. 10 is a guidance screen D4 displayed on the display unit 41 when the book scan mode and the automatic mode are selected. The guidance screen D4 includes a message MS1 indicating that the book scan mode is selected and a message MS2 prompting the user to open the document cover 15. The user opens the document cover 15 in the closed state illustrated in FIG. 1 in the image reading apparatus 11 to bring the document cover 15 into the open state illustrated in FIG. 2. The control unit 50 detects that the document cover 15 is changed from the closed state to the open state based on the detection signal of the opening and closing sensor 23.

FIG. 11 illustrates a guidance screen D5 displayed on the display unit 41 when the user opens the document cover 15 in the book scan mode. The guidance screen D5 includes a message MS3 prompting the user to dispose (place) the document M1 with the reading surface of the document M1 aligned with a left back corner of the document table 12. A region of the document M1 (book B1) indicated by a two-dot chain line in FIG. 12 is a placement position where the reading surface of the document M1 is to be placed. In a plan view of the placement surface 12A illustrated in FIG. 12, a position at which the reading surface of the document M1 is disposed according to a left back corner (upper left corner in FIG. 12) of the placement surface 12A is a placement position at which the document M1 is to be placed.

When the open state of the document cover 15 illustrated in FIGS. 2 and 12 is detected based on the detection signal of the opening and closing sensor 23, the control unit 50 moves the reading module 20 to a predetermined position indicated by a solid line in FIG. 12 and turns on the light emitting unit 18. Specifically, in FIG. 12, a position in a region between the document reading region SA and the reading window portion 21 in the sub scanning direction Y is the standby position P0 of the reading module 20. In the book scan mode, when the document cover 15 is switched from the closed state to the open state, the control unit 50 moves the reading module 20 from the standby position P0 indicated by the two-dot chain line in FIG. 12 to a predetermined position P1 indicated by a solid line in FIG. 12. Then, the control unit 50 turns on the light emitting unit 18 in a state in which the reading module 20 is disposed at the predetermined position P1. A turning-on start timing of the light emitting unit 18 may be in a state in which the reading module 20 is at the standby position P0 before the start of the movement, may be after the reading module 20 finishes moving to the predetermined position P1 which is a target position, or may be during the movement of the reading module 20 from the standby position P0 to the predetermined position P1. The light emitting unit 18 may start turning-on at least before the start of a predetermined period (for example, a predetermined value within a range of 1 to 10 seconds) in which the document detection process is performed after the reading module 20 finishes moving to the predetermined position P1.

The user places the document M1 to cover the reading module 20 turned on at the predetermined position P1 indicated by the solid line in FIG. 12 from above. That is, the user places the document M1 on the placement surface 12A in a state in which the reading module 20 (particularly, the reading unit 17) and the reading surface (for example, a reading target page) of the document M1 (book B1) face each other in the vertical direction Z.

### Display Control Method of Image Reading Apparatus 11

The control unit 50 causes the display unit 41 to display guidance information for guiding the placement of the document M1 at the position indicated by the turning-on of the light emitting unit 18. For example, the control unit 50 causes the display unit 41 to display the guidance information as the user interface (GUI) for notifying information.

When execution of reading of a document is instructed in an open state in which the document cover 15 is opened with respect to the document table 12, guidance information for guiding a document placement position, which is a position where the document M1 is placed on the placement surface 12A of the document table 12, is displayed on the display unit 41.

The display control method of the image reading apparatus includes the following (a2) and (b2).
(a2) It is instructed to read the document M1 in an open state in which the document cover 15 is opened with respect to the document table 12.
(b2) When execution of reading of the document M1 is instructed, the guidance information for guiding a placement position which is a position where the document M1 is placed on the document table 12 is displayed on the display unit 41.

The control unit 50 causes the display unit 41 to display the guidance screen D5 including the guidance information illustrated in FIG. 11 as an example of the guidance information. The guidance screen D5 illustrated in FIG. 11 includes the message MS3 as an example of guidance information for guiding a placement position that is a position where the document M1 is placed on the placement surface 12A of the document table 12. The message MS3 includes, for example, information such as “please place the document with the reading surface of the document aligned with the left back corner of the document table”.

The user recognizes a document placement position, which is a position where the document M1 is to be placed on the placement surface 12A, by the message MS3 in the guidance screen D5. In the present embodiment, the user is guided to the document placement position on the placement surface 12A by turning on the light emitting unit 18 at the predetermined position P1 indicating the document placement position and displaying the message MS3, which is an example of the guidance information, on the display unit 41. Therefore, the user can place the document M1 at an appropriate placement position on the placement surface 12A.

The document placement position is a position where the reading unit 17 disposed at the document detection position P1, which is an example of a predetermined position, can detect the document M1. In the image reading apparatus 11, the reading module 20 is turned on (including blinking) at the predetermined position P1 in the document reading region SA. The user places the document M1 at a predetermined position (for example, the document detection position P1) indicated by turning-on. Accordingly, the image reading apparatus 11 can guide the user to place the document M1 at the document detection position P1 at which the placement of the document M1 on the placement surface 12A can be detected.

### Document Detection Process

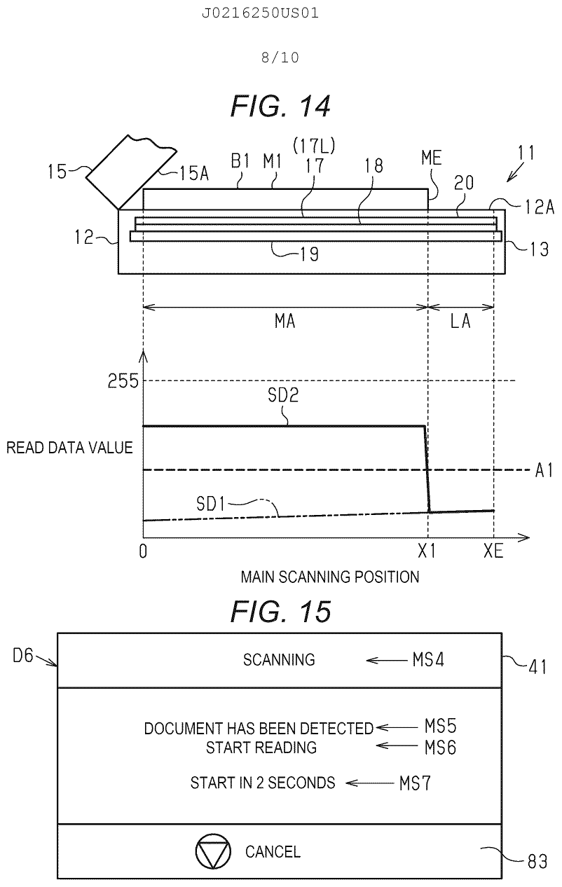

Next, the document detection process will be described with reference to FIG. 14. FIG. 14 illustrates a schematic side cross-sectional view of the document table 12 on which the book B1 is placed and a graph illustrating a reading result of the reading unit 17. The control unit 50 executes the document detection process of causing the reading unit 17 to perform reading in a state in which the document cover 15 is in the open state and the light emitting unit 18 is turned on. The document detection process is a reading process for detecting that the document M1 is placed on the placement surface 12A. That is, in the present embodiment, the reading unit 17 is used to detect that the document M1 is placed on the placement surface 12A.

The control unit 50 causes the reading unit 17 to perform reading in a state in which the light emitting unit 18 is turned on from a time point when the document cover 15 is in the open state and before the document M1 is placed on the placement surface 12A. The control unit 50 executes the document detection reading process based on a result of the opening and closing sensor 23 detecting the open state of the document cover 15. The control unit 50 executes the document detection reading process in a state in which the reading unit 17 is disposed at the predetermined position P1 in the document reading region SA of the placement surface 12A.

The graph illustrated in FIG. 14 illustrates the reading result of the reading unit 17 (line sensor 17L). A horizontal axis of the graph is the main scanning position indicating the position of each of the plurality of image sensors 28, and a vertical axis is a read data value. Here, the main scanning position corresponds to a pixel position indicating a position in the main scanning direction X of a plurality of (m) image sensors 28 constituting the reading unit 17. The read data value indicates a luminance value equivalent to a signal value at the time when luminance signals input from the plurality of image sensors 28 are converted into digital signals having predetermined tones (for example, 256 tones).

A reading result SD1 indicated by a two-dot chain line in the graph illustrated in FIG. 14 indicates a reading result before the document cover 15 is in the open state and the document M1 is placed on the placement surface 12A. A reading result SD2 indicated by a solid line in the graph illustrated in FIG. 14 indicates a reading result when the document M1 is placed on the placement surface 12A. The reading results SD1 and SD2 are indicated by read data in which the luminance value corresponding to a light receiving amount obtained by the image sensor 28 for each main scanning position is represented by, for example, 256 tones. Each of the reading results SD1 and SD2 indicates read data per reading of the line sensor 17L. The control unit 50 detects whether the document M1 is placed on the placement surface 12A based on the reading results SD1 and SD2 of the reading unit 17. That is, the control unit 50 determines that the document M1 is detected when there is a read data value (luminance value) exceeding a threshold A1 in the reading results SD1 and SD2.

As illustrated in FIG. 14, in a stage before the document M1 is placed on the placement surface 12A in which the document cover 15 is in the open state, a reading result SD1 indicated by a two-dot chain line in the graph of FIG. 14 is obtained. Since the reading unit 17 does not receive the reflected light from the document M1, there is no read data value exceeding the threshold A1. In this case, the control unit 50 does not detect that the document M1 is placed on the placement surface 12A.

On the other hand, when the document M1 is placed on the placement surface 12A, the reading unit 17 receives the reflected light from the document M1. Therefore, a reading result SD2 indicated by a solid line in FIG. 14 in which the read data exceeding the threshold A1 is present is obtained. A falling position X1 of the reading result SD2 corresponds to a position of a boundary between a bright region MA due to the reflected light of the book B1 and a dark region LA that does not receive the reflected light of the book B1. That is, the falling position X1 is a position corresponding to an end surface ME on the +X side of the book B1 placed on the placement surface 12A. Since there is read data exceeding the threshold A1 in the reading result SD2, the control unit 50 detects that the document M1 is placed. As described above, the control unit 50 performs the document detection process of detecting whether the document M1 is placed on the placement surface 12A based on the reading results SD1 and SD2.

In the document detection process, the above-described reading process in which reading is performed in a state in which the document cover 15 is in the open state and the light emitting unit 18 is turned on is referred to as a reading process A. The document detection process may include, in addition to the reading process A, a reading process B of reading in a state in which the document cover 15 is in the open state and the light emitting unit 18 is turned off. In this case, based on a difference between a reading result of the reading process A and a reading result of the reading process B, since there is data in which differential data exceeds a threshold, the control unit 50 may detect that the document M1 is placed on the placement surface 12A.

In a mode other than the book scan mode, the document detection process may include a reading process C for reading in the closed state of the document cover 15. For example, the document detection process may include the reading process A, the reading process B, and the reading process C that is reading in a state in which the document cover 15 is closed and the light emitting unit 18 is turned on. When a black document M1 is placed on the placement surface 12A, since the differential data between the reading result of the reading process A and the reading result of the reading process B does not exceed the threshold, the presence or absence of the black document M1 cannot be detected. However, the control unit 50 may detect the presence or absence of the black document M1 based on the differential data and a reading result of the reading process C. That is, when the differential data is smaller than the threshold and the reading result of the reading processing C is smaller than the threshold, the control unit 50 determines that the document M1 has been placed on the placement surface 12A. On the other hand, when the differential data is smaller than the threshold and the reading result of the reading process C is equal to or larger than the threshold, the control unit 50 determines that the document M1 is not placed on the placement surface 12A. By the determination, it is also possible to detect that the black document M1 is placed on the placement surface 12A.

### Regarding FB Type Document Reading Process

Next, the document reading process in which the reading module 20 reads the document M1 using the FB type will be described. Contents of the document reading process are the same in the normal mode and the automatic mode or the manual mode of the book scan mode. The control unit 50 starts the document reading process based on establishment of a reading start trigger. The control unit 50 controls the carriage motor 43 to move the carriage 19 in the document reading region SA along the placement surface 12A in the sub scanning direction Y. The control unit 50 (for example, the light emission control unit 63) turns on the light emitting unit 18 during document reading. The control unit 50 (for example, the reading control unit 62) causes the reading unit 17 to read the document M1 through the transparent plate 14 in a state in which the light emitting unit 18 is turned on during the movement of the carriage 19. The reading unit 17 reads the document M1 by receiving the reflected light of light emitted by the light emitting unit 18 and reflected on the document M1. The control unit 50 acquires, from the reading control unit 62, read data read by the reading unit 17 in the document reading process. The control unit 50 generates image data by performing a necessary image process on the read data for each page. The control unit 50 executes a filing process of filing the image data into a file in a predetermined file format. The control unit 50 generates scan data in a predetermined file format by converting the image data into a file.

### Operation of Embodiment

Next, an operation of the image reading apparatus 11 is described with reference to FIG. 9 and the like. Hereinafter, the book scan processing routine illustrated in FIG. 9 executed by the control unit 50 will be described. By operating the input unit 42, the user selects a reading condition, selects a mode, and issues a document reading start instruction (scan start instruction). The control unit 50 executes a book scan processing routine illustrated in FIG. 9. In the book scan processing routine, when the control unit 50 receives a job start instruction in the book scan mode, the control unit 50 automatically starts reading (scanning) the document M1 every time it detects that the document M1 is placed on the placement surface 12A of the document table 12.

First, in step S11, the control unit 50 determines whether the book scan mode is selected and the job start button 71 is pressed. When the control unit 50 receives the selection of the book scan mode based on the pressing of the mode selection button 70 on the selection screen D1 and the job start instruction in the automatic mode based on the pressing of the job start button 71, the process proceeds to step S12. Otherwise, the control unit 50 waits until the book scan mode is selected and the job start button 71 is pressed.

In step S12, the control unit 50 transitions to the book scan mode. Specifically, the control unit 50 transitions to the automatic mode of the book scan mode. At this time, the control unit 50 shifts from the standby state to the document placement waiting state (document setting waiting state) in which the user waits for a user operation of placing the document M1 (book B1) on the placement surface 12A.

In step S13, the control unit 50 displays the guidance information prompting an opening operation of the document cover. For example, the control unit 50 causes the display unit 41 to display the guidance screen D4 illustrated in FIG. 13. The guidance screen D4 includes, as the guidance information, the message MS1 indicating that the book scan mode is selected and the message MS2 prompting the user to open the document cover. As described above, the control unit 50 causes the display unit 41 to display the guidance screen D4 including the message MS2 prompting the user to open the document cover in the document placement waiting state. The user changes the document cover 15 from the closed state illustrated in FIG. 1 to the open state illustrated in FIG. 2 according to the guidance of the message MS2.

In step S14, the control unit 50 determines whether the document cover 15 is in the open state. The control unit 50 determines whether the document cover 15 is in the open state based on a determination result of the opening and closing determination unit 66 based on the detection signal of the opening and closing sensor 23. The control unit 50 proceeds the process to step S15 when the document cover 15 is in the open state, and returns the process to step S13 when the document cover 15 is not in the open state. In this case, the control unit 50 displays the guidance information for prompting an opening operation of the document cover 15 in step S13 until it is determined in step S14 that the document cover 15 is in the open state.

In step S15, the control unit 50 moves the carriage 19 to the document detection position P1. The control unit 50 drives the carriage motor 43 in a forward direction to move the carriage 19 from the standby position P0 to the document detection position P1, which is an example of a predetermined position. The document detection position P1 is a position at which the reading unit 17 detects whether the document M1 is placed on the placement surface 12A. The document detection position P1 according to the present embodiment is a position where the document M1 is placed so that the corner of the document M1 is aligned with the left back corner of the placement surface 12A (see FIG. 12). Therefore, the document detection position P1 is set at a position close to a left end (end portion on the −Y direction side) in the placement surface 12A (document reading region SA). Here, the document detection position P1 (predetermined position) is a position within the range YA of a predetermined distance from the starting end Y0 of the placement surface 12A in the +Y direction side.

In step S16, the control unit 50 starts detection of a document. The control unit 50 turns on the light emitting unit 18 and causes the reading unit 17 to start reading. The control unit 50 starts the document detection process of detecting whether the document M1 is placed on the placement surface 12A based on the reading result of the reading unit 17. The turning-on of the light emitting unit 18 at this time may be, for example, blinking. In this case, the control unit 50 causes the light emission control unit 63 to blink the light emitting unit 18 at a predetermined cycle. As illustrated in FIG. 12, the light emitting unit 18 of the reading module 20 blinks at the document detection position P1. The position where the light emitting unit 18 of the reading module 20 blinks guides the user to a document placement position where the document M1 is to be placed. The blinking at the reading module 20 has a guide function of guiding the user where the document detection position P1 is. The blinking at the reading module 20 also has a function of notifying the user that the image reading apparatus 11 is in the book scan mode or is in the document placement waiting state.

In the next step S17, the control unit 50 displays the guidance information prompting the placement of the document on the placement surface. For example, the control unit 50 causes the display unit 41 to display a guidance screen D5 illustrated in FIG. 11. The guidance screen D5 includes, as the guidance information, guidance of the document placement position and the message MS3 prompting the user to place the document M1 at the document placement position. According to the guidance of the message MS3, as illustrated in FIGS. 12 and 13, the user places the document M1 (book B1) at the document detection position P1 to cover a blinking position on the placement surface 12A from above. That is, the user places the book B1 at the document placement position close to the left back side on the placement surface 12A. In this way, the book B1 is placed on the placement surface 12A at a position readable by the reading unit 17. The guidance screen D5 includes a setting button 81 and an end button 82. When the setting button 81 is selected, the control unit 50 causes the display unit 41 to display the first setting screen D2 illustrated in FIG. 7 or the second setting screen D3 illustrated in FIG. 8. The user changes the predetermined time T, which is an elapsed time from a time point when the book B1 is placed to the start of reading, as necessary on the setting screens D2 and D3. The user presses the end button 82 to end the book scan mode.

In the next step S18, the control unit 50 determines whether the end button 82 is pressed. The control unit 50 proceeds the process to step S19 when the end button 82 is not pressed, and proceeds the process to step S24 when the end button 82 is pressed. Since not even a single page of the book B1 has been read yet, it is unlikely that the user will press the end button 82. Therefore, the process normally proceeds to step S19.

In the next step S19, the control unit 50 determines whether a document is detected. The control unit 50 determines whether the document is detected by the document detection process. The control unit 50 causes the light emitting unit 18 to blink in the document detection process. The control unit 50 executes the document detection process when the light emitting unit 18 is turned on or off. Here, the document detection process will be described with reference to FIG. 14. In a stage before the book B1 is placed on the placement surface 12A, the reading unit 17 does not receive the reflected light from the book B1 even when the light emitting unit 18 of the reading module 20 is turned on. Therefore, the reading result SD1 indicated by the two-dot chain line in FIG. 14 does not contain any read data that exceeds the threshold A1 at any main scanning position. Thereafter, when the book B1 is placed on the placement surface 12A, the light where the light is turned on by the light emitting unit 18 of the reading module 20 is reflected by a paper surface of the reading target page of the book B1, and the reading unit 17 receives the reflected light from the book B1. As a result, the read data value at the main scanning position in the region where the book B1 is placed in the reading result SD2 indicated by the solid line in FIG. 14 exceeds the threshold A1. The control unit 50 detects that the document M1 (book B1) is placed on the placement surface 12A when there is read data exceeding the threshold A1. When the document is detected, the control unit 50 proceeds the process to step S20. On the other hand, when no document is detected, the control unit 50 returns the process to step S17, and repeats the process of steps S17 to S19 until a document is detected in step S19.

In step S20, the control unit 50 displays that scanning is in progress. For example, the control unit 50 causes the display unit 41 to display the notification screen D6 illustrated in FIG. 15. The notification screen D6 includes a message MS4 indicating that the scanning is in progress as the notification information. However, the notification screen D6 illustrated in FIG. 15 is a screen in a state before the start of scanning. Therefore, the notification screen D6 includes a message MS5 indicating that the document is detected, a message MS6 indicating that the reading is started, and a message MS7 indicating the remaining time (seconds) until the reading is started in the predetermined time T. The notification screen D6 includes a cancel button 83. When the reading (scanning) is started, the messages MS5 to MS7 may disappear and the notification screen D6 may be switched to the display content indicating the scanning state. When the cancel button 83 is pressed on the notification screen D6, the control unit 50 cancels the reading (scanning) of the book B1.

In step S21 illustrated in FIG. 9, the control unit 50 executes a document reading process. The control unit 50 moves the reading module 20 from the document detection position P1 (see FIG. 13) to the reading start position Y0 on a second direction −Y side. The control unit 50 executes reading process of causing the reading module 20 to read the book B1 by moving the reading module 20 from the reading start position Y0 in the first direction +Y. For example, the reading module 20 moves in the first direction +Y from the reading start position Y0 to a reading end position PE, and moves in the second direction −Y from the reading end position PE to the document detection position P1. Here, the reading end position PE may be the terminal end YE of the document reading region SA, or may be an end portion position YM of the book B1 on the first direction +Y side or a position obtained by adding a predetermined margin distance to the end portion position YM. In this case, the control unit 50 may detect the presence or absence of the book B1 based on the read signal from the reading module 20 during the reading process, and acquire the position where the book B1 is no longer detected from the state in which the book B1 is detected as the end portion position YM of the book B1.

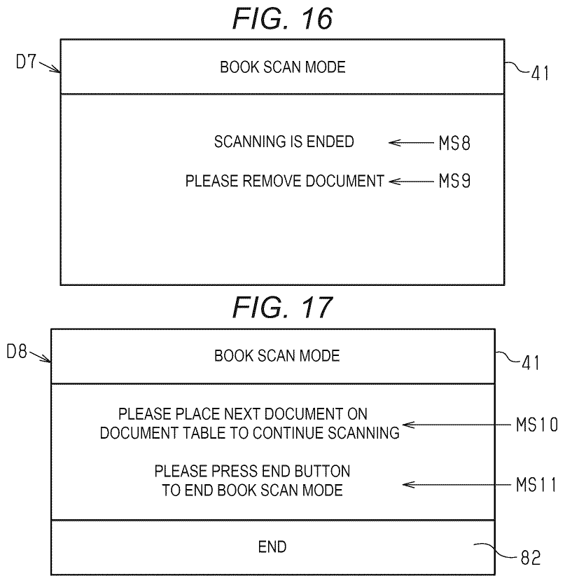

In step S22, the control unit 50 displays the guidance information prompting removal of the document. For example, the control unit 50 causes the display unit 41 to display a guidance screen D7 illustrated in FIG. 16. The guidance screen D7 includes a message MS9 prompting the user to remove the document as the guidance information. The guidance screen D7 may include, as the notification information, a message MS8 for notifying that the scanning (reading of the document) is ended. The user who views the guidance screen D7 removes the book B1 from the placement surface 12A according to the guidance of the message MS9. Since the user knows that the scanning may be ended and the book B1 may be removed from the placement surface 12A from the guidance information by the message MS9, convenience is improved. For example, it is possible to reduce a useless waiting time for waiting for a while while holding the book B1 even though the scanning is ended. This leads to a reduction in the time required for reading a plurality of pages of the book B1.

In the next step S23 in FIG. 9, the control unit 50 determines whether the removal of the document is detected. The control unit 50 determines whether a document detection result is changed from a document detection state in which the book B1 is detected to a document non-detection state in which the book B1 is not detected by a process similar to the document detection process in steps S16 and S19. Specifically, the control unit 50 turns on the light emitting unit 18 and causes the reading unit 17 to start reading. The control unit 50 determines whether the document M1 on the placement surface 12A has run out based on the reading result of the reading unit 17. The turning-on of the light emitting unit 18 at this time may be, for example, blinking. In this case, the control unit 50 may cause the light emission control unit 63 to blink the light emitting unit 18 at a predetermined cycle. Alternatively, the control unit 50 may detect the removal of the book in a state in which the light emitting unit 18 is continuously turned on. The control unit 50 returns to step S22 while the removal of the document M1 (book B1) is not detected, and continues to display the guidance information prompting the removal of the document. On the other hand, when the removal of the document is detected, the control unit 50 returns to step S16. At this time, the control unit 50 shifts from a document removal waiting state to the document placement waiting state. The reading module 20 that ends the document reading process moves to the predetermined position P1.

In step S16, the control unit 50 starts detection of a document. That is, the control unit 50 that has shifted to the document placement waiting state starts the document detection process of detecting whether the document M1 changed to the next page is placed on the placement surface 12A. Specifically, the control unit 50 turns on the light emitting unit 18 and causes the reading unit 17 to start reading. The control unit 50 determines whether the document M1 is placed on the placement surface 12A based on the reading results SD1 and SD2 of the reading unit 17 illustrated in FIG. 14. At this time, the light emitting unit 18 blinks at a predetermined cycle, for example. When the user places the book B1 changed to the next page on the placement surface 12A, as illustrated in FIG. 12, the image reading apparatus 11 guides the user to the document placement position by blinking the reading module 20 at the document detection position P1.

Then, in step S17, the control unit 50 causes the display unit 41 to display the guidance information prompting the placement of the document on the placement surface 12A. For example, the control unit 50 causes the display unit 41 to display a guidance screen D8 illustrated in FIG. 17. The control unit 50 counts the number of pages to be read of the document by a counter (not illustrated), and may display the guidance screen D8 on the display unit 41 when reading the second and subsequent pages. The guidance screen D8 includes a message MS10 prompting the user to place the next document on the placement surface 12A, and the end button 82. Further, the guidance screen D8 may include a message MS11 indicating that the end button 82 is pressed to end the book scan mode.

In this way, the user places the book B1 on the placement surface 12A while changing the page of the book B1 according to the guidance information and the notification information displayed on the display unit 41, thereby causing the image reading apparatus 11 to read a desired page of the book B1. The control unit 50 repeatedly executes the processes of steps S16 to 23 until the end button 82 is pressed in step S18. When the user finishes reading all the desired pages of the book B1, the user presses the end button 82 on the guidance screen D8 illustrated in FIG. 17. When the pressing of the end button is detected in step S18, the control unit 50 proceeds the process to step S24.

In step S24, the control unit 50 generates scan data. For example, the control unit 50 executes a filing process of combining the image data of a plurality of pages obtained by reading a plurality of pages of the book B1 into one file. For example, the control unit 50 converts the image data of a plurality of pages of the book B1 into one file in a predetermined file format. The predetermined file format is, for example, a PDF file. The control unit 50 generates, as the scan data, a PDF file in which the image data for a plurality of pages is combined into one file.

The book scan processing routine described above executes the document reading process of causing the reading unit 17 to read the document M1 based on the elapse of the predetermined time T from the time point when the conditions of (a1) to (c1) described above are satisfied. In the example illustrated in FIG. 9, the (a1) corresponds to a positive determination as the result of the determination process in step S11. In the example illustrated in FIG. 9, the (b1) corresponds to a positive determination as the result of the determination process in step S14. In the example illustrated in FIG. 9, the (c1) corresponds to a positive determination as the result of the determination process in step S19.

### Effects of Embodiment

According to the embodiment, effects described below can be obtained.

(1) The image reading apparatus 11 includes the document table 12, the document cover 15, the reading unit 17, the light emitting unit 18, and the control unit 50. The document table 12 has the placement surface 12A on which the document M1 is to be placed. The document cover 15 opens and closes the placement surface 12A of the document table 12. The reading unit 17 reads, on the side opposite to the placement surface 12A, the document M1 placed on the placement surface 12A of the document table 12. The light emitting unit 18 is configured to be switchable between turning-on and turning-off. When reading of the document M1 is performed in an open state in which the document cover 15 is opened with respect to the document table 12, the control unit 50 turns on the light emitting unit 18 at a predetermined position of the placement surface 12A before the document M1 is placed on the placement surface 12A of the document table 12 in the open state. According to the configuration, by turning on the light emitting unit 18 at a predetermined position of the placement surface 12A before the document M1 is placed on the document table 12, it is possible to guide or notify the user of information necessary for reading the document M1 from now on. Therefore, convenience for the user can be improved. The necessary information includes information indicating that the image reading apparatus 11 is in an appropriate document reading mode, information indicating that the image reading apparatus 11 is in a predetermined state, information indicating a position to be guided or notified to the user by a predetermined position to be turned on, and the like. The predetermined state of the image reading apparatus 11 includes a waiting state in which the image reading apparatus 11 waits for a predetermined operation by the user, a standby state until the start of document reading, and the like. The information on the position to be guided or notified to the user includes a placement position where the user is to place the document M1, a document detection position where the placement of the document M1 can be detected, a document placement position where reading of the document M1 can be started, and the like.

(2) The turning-on of the light emitting unit 18 indicates a placement position that is a position on the placement surface 12A of the document table 12 where the document M1 is placed. According to the configuration, since the position where the document M1 is placed on the document table 12 can be indicated by turning on the light emitting unit 18, it is possible to guide the user to the position where the document M1 is placed. The convenience for the user can be improved.

(3) The document table 12 has translucency. The light emitting unit 18 is provided on an opposite side from the placement surface 12A of the document table 12. Light can be emitted to the outside of the placement surface 12A from the opposite side of the document table 12. According to the configuration, the placement position can be indicated from the opposite side of the placement surface 12A of the document table 12.

(4) The light emitting unit 18 illuminates the document M1 by being turned on when the reading unit 17 reads the document M1. According to the configuration, the position where the document M1 is placed can be indicated by the light emitting unit 18, and the document M1 can be illuminated when the reading unit 17 reads the document M1 by the light emitting unit 18.

(5) The control unit 50 causes the light emitting unit 18 to blink to indicate the placement position. According to the configuration, it is easy for the user to recognize the placement position.

(6) The control unit 50 detects that the document M1 is placed on the placement surface 12A based on the reading results SD1 and SD2 obtained when the reading unit 17 is caused to perform reading while the light emitting unit 18 is turned on during blinking. According to the configuration, it is possible to detect that the document M1 is placed on the placement surface 12A based on the reading results SD1 and SD2 obtained by the reading unit 17.

(7) The control unit 50 executes the document reading process of causing the reading unit 17 to read the document M1 based on detection that the document M1 is placed on the placement surface 12A. According to the configuration, since the reading by the reading unit 17 can be started based on the detection of the placement of the document M1, the convenience for the user is improved.

(8) The image reading apparatus further includes the display unit 41 that displays information. The control unit 50 causes the display unit 41 to display guidance information for guiding the placement of the document M1 at the position indicated by the lighting of the light emitting unit 18. According to the configuration, it is easier to guide the user to place the document M1 by the guidance information displayed on the display unit 41.

(9) The reading unit 17 and the light emitting unit 18 are integrated. In the present embodiment, the reading unit 17 and the light emitting unit 18 are integrated into the reading module 20. According to the configuration, since the reading unit 17 and the light emitting unit 18 are integrated, when the light emitting unit 18 is moved to the placement position, the reading unit 17 can perform reading for document detection at the placement position. For example, since the reading unit 17 and the light emitting unit 18 can share the carriage 19 constituting the movement mechanism, it is not necessary to separately provide a movement mechanism dedicated to the light emitting unit. Therefore, it is possible to relatively easily implement a configuration in which the placement position of the document M1 is indicated by turning-on.

(10) The image reading apparatus 11 includes the document table 12 having the placement surface 12A on which the document M1 is to be placed, the document cover 15 that opens and closes the placement surface 12A with respect to the document table 12, the reading unit 17 that reads the document M1 placed on the placement surface 12A of the document table 12 on an opposite side from the placement surface 12A, and the control unit 50. In a mode in which reading of the document M1 is performed in an open state in which the document cover 15 is opened with respect to the document table 12, the control unit 50 executes a document reading process of causing the reading unit 17 to read the document M1 based on an elapse of a predetermined time from a time point when three conditions of (a1) to (c1) below are satisfied.
(a1) The start of the reading job is instructed by the user.
(b1) The document cover 15 is in the open state.

(c1) The document M1 is placed on the document table 12.

According to the configuration, in the mode in which the reading of the document M1 is performed in the open state, since one of the start conditions of the reading process is that the start of the reading job is instructed by the user, it is possible to cause the user to recognize that the reading job is started, and thus it is possible to improve the convenience for the user.

(11) The image reading apparatus 11 includes an adjustment unit that adjusts a predetermined time. The adjustment unit is implemented by a GUI displayed on the display unit 41 so that the user can adjust the predetermined time. It is easy to avoid a situation in which an alignment time in which the reading of the book B1 by the reading module 20 is started during the alignment of the book B1 by the user is too short and a situation in which a waiting time from the end of the alignment of the book B1 by the user to the start of the reading is too long. For example, when the book B1 that is difficult to align is read or when a careful alignment operation is required, an operation time required for alignment can be secured by adjusting the predetermined time to be long. In addition, when the book B1 of a type that is easily aligned is read or when a careful alignment operation is not required, the predetermined time is adjusted to be short, and thus it is possible to implement speedy reading while securing an operation time required for alignment.

(12) The reading unit 17 includes a contact image sensor. According to the configuration, since the reading unit 17 is a contact image sensor having a smaller depth of field than a charge coupled device (CCD) image sensor, the user needs to firmly press the book B1 so that the entire page to be read of the book B1 can be brought close to the placement surface 12A. When the user is forced to perform other operations, or when the user removes the line of sight from the document M1 such as the book B1 in order to confirm a display screen, the user's awareness of the document M1 such as the book B1 will decrease. Then, the document M1 such as the book B1 pressed by the user in the aligned state is likely to be displaced or lifted. However, according to the configuration, since the reading of the document M1 such as the book B1 is automatically started, the user can concentrate on the operation of pressing the document M1 such as the book B1 in the aligned state. Therefore, when the reading of the document M1 such as the book B1 is started, the document M1 such as the book B1 is unlikely to be displaced or lifted. Therefore, even with a contact image sensor having a relatively narrow depth of field, it is possible to read an image of the document M1 such as the book B1 with little displacement and little blur.

(13) The image reading apparatus 11 further includes the opening and closing sensor 23 that detects opening and closing of the document cover 15, and the job start button 71 that receives an instruction to start a reading job of the document M1. The control unit 50 receives an instruction to start a reading job via the job start button 71, detects the open state by the opening and closing sensor 23, and executes the document reading process after a predetermined time elapses since it is detected that the document M1 is placed on the document table 12 based on a reading result obtained by the reading unit 17. According to the configuration, after the user instructs the start of the reading job via the job start button 71, there is a predetermined time until the reading is started after the user places the document M1 on the placement surface 12A of the document table 12 in the open state. Therefore, the user can position the document M1 on the placement surface 12A.

(14) A display control method for the image reading apparatus 11 including the document table 12, the document cover 15, the reading unit 17 that reads the document M1 placed on the placement surface 12A of the document table 12 on an opposite side from the placement surface 12A, and the display unit 41 that displays information, which includes the following (a2) and (b2).
(a2) It is instructed to read the document M1 in an open state in which the document cover 15 is opened with respect to the document table 12.
(b2) When execution of reading of the document M1 is instructed, the guidance information for guiding a placement position which is a position where the document M1 is placed on the document table 12 is displayed on the display unit 41. According to the method, it is possible to guide the placement position at which the document M1 is placed on the placement surface 12A of the document table 12 by the guidance information displayed on the display unit 41 to the user who instructs the performing of the reading of the document M1. Specifically, when the user instructs to start execution of the book scan mode, the image reading apparatus 11 enters a document placement waiting state. The image reading apparatus 11 causes the display unit 41 to display the guidance information when the user performs an operation of placing the document M1 to be performed next on the placement surface 12A in the document M1 waiting state. Accordingly, it is possible to guide the placement position at which the document M1 is placed on the placement surface 12A of the document table 12 to the user. Therefore, convenience for the user can be improved.

### Modifications

The above embodiment may be modified as the following modifications. Further, an appropriate combination of the embodiment described above and the modifications described below can be obtained as another modification and an appropriate combination of the modifications described below can be obtained as another modification.

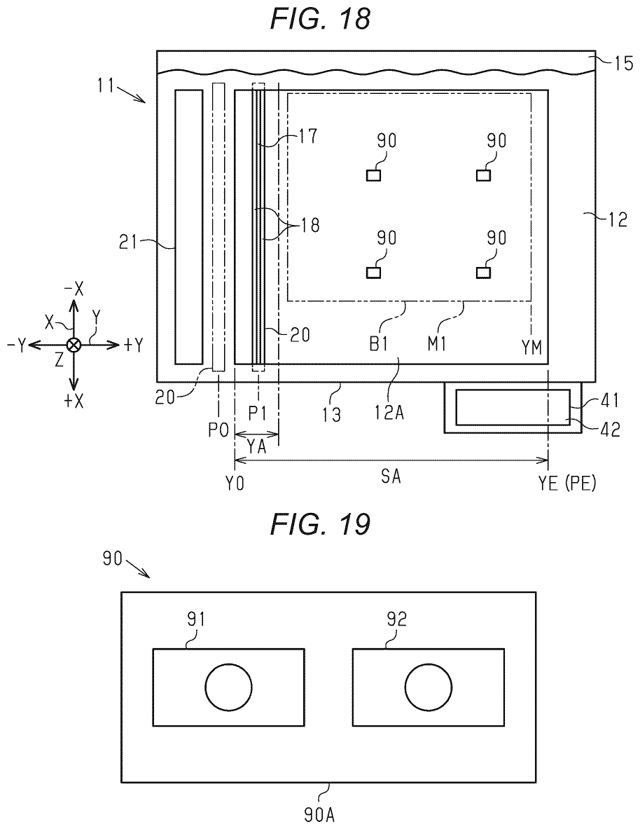

A sensor that detects that the document M1 is placed on the placement surface 12A may be provided separately from the reading unit 17. For example, as illustrated in FIG. 18, at least one document detection sensor 90 may be provided at a position different from the predetermined position P1 of the reading unit 17 in the document reading region SA of the placement surface 12A in a plan view of the document table 12 of the image reading apparatus 11. In the example illustrated in FIG. 18, in the document reading region SA corresponding to the placement surface 12A, four sensors 90 are disposed at four positions different from the predetermined position P1 of the reading unit 17. As illustrated in FIG. 19, the sensor 90 includes a light emitting element 91 and a light receiving element 92. The light emitting element 91 and the light receiving element 92 are supported by a substrate 90A at respective positions satisfying a positional relationship in which the light receiving element can receive reflected light obtained by light from the light emitting element 91 hitting a reading surface of the document M1 and being reflected. According to the configuration, it is possible to detect the placement of the document M1 on the placement surface 12A even when the document M1 (book B1) is placed at the placement position indicated by the two-dot chain line in FIG. 18 deviated from the reading unit 17 disposed at the predetermined position P1. Therefore, a degree of freedom of the placement position of the document M1 placed on the placement surface 12A by the user is improved. As described above, the light emission of the reading unit 17 moved to the predetermined position P1 and the light emission of at least one of the sensors 90 may guide the placement position of the document M1 to the user.

The document M1 (book B1) placed on the placement surface 12A may be detected by a sensor different from the reading unit 17. For example, the placement of the document may be detected by a photosensor (optical sensor) instead of the reading module 20 (CIS module). The sensor is not limited to a photosensor and may be an ultrasonic sensor. That is, the sensor may be a non-contact sensor such as an optical sensor or an ultrasonic sensor. The sensor may be attached to a predetermined position in the housing 13 of the document table 12, may be provided in the carriage 19, or may be provided in a dedicated carriage different from the carriage 19.

The document detection position P1 at which the reading module 20 (reading unit 17) detects the document M1 placed on the placement surface 12A and a document removal detection position at which the reading module 20 detects the removal of the document M1 may be different positions. In this case, the control unit 50 may be implemented such that the reading module 20 that detects the removal of the document at the document removal detection position in step S23 moves from the document removal detection position to the document detection position P1.

A document removal detection process may be started while the reading module 20 that finishes reading the document moves to the document detection position P1. According to the configuration, when the user removes the document M1 immediately after finishing reading the document M1, the removal of the document M1 can be detected early.

The turning-on of the light emitting unit 18 when the image reading apparatus 11 is in the document placement waiting state may be, instead of blinking, continuous turning-on in which the light emitting unit 18 is maintained in a turn-on state.

In the blinking in which a turn-on time and a turn-off time of the light emitting unit 18 are alternately repeated, the turn-on time and the turn-off time may be the same, or one may be longer than the other. For example, the turn-on time may be longer than the turn-off time, or conversely, the turn-on time may be shorter than the turn-off time. The turn-on time may be set to a time in which a reading time required for one detection process of the document M1 can be secured or a time in which a time N times (N is a natural number of 2 or more) the reading time can be secured.

The blinking of the light emitting unit 18 is not limited to the configuration in which the light emitting unit 18 is alternately turned on and off, and may be blinking including a turn-on state in which the brightness during turning-on changes stepwise. Further, the turning-on of the light emitting unit 18 may be turning-on in which the light emitting unit 18 is not turned off and the brightness during turning-on changes stepwise.

The light emitting unit that emits light at the predetermined position P1 in the document placement waiting state is not limited to the configuration in which the light emitting unit 18 for document illumination that illuminates the document M1 at the time of scanning also functions. That is, the light emitting unit may be other than the light emitting unit 18 constituting the reading module 20. For example, a light emitting unit dedicated to document detection may be provided in the carriage 19 separately from the light emitting unit 18 for document illumination.

The reading unit 17 and the light emitting unit 18 may be integrated in a form different from the reading modules 20 (CIS). For example, the reading unit 17 and the light emitting unit 18 may be integrated by being assembled to a common support member attached to the carriage 19.

The light emitting unit 18 may not be integrated with the reading unit 17. That is, the light emitting unit 18 may not constitute the reading modules 20 (CIS) integrated with the reading unit 17. For example, the reading unit 17 and the light emitting unit 18 may be separately assembled to the carriage 19. In this case, the light emitting unit may be a light emitting unit dedicated to document detection different from the light emitting unit 18 for document illumination.

The light emitting unit may be a light emitting unit dedicated to turning-on guidance provided separately from the light emitting unit 18 constituting the reading module 20. The light emitting unit dedicated to the turning-on guidance may be provided in the carriage 19 together with the reading module 20, or may be movably provided via a dedicated carriage different from the carriage 19. The dedicated carriage may be implemented to be movable only in the sub scanning direction Y similarly to the carriage 19, may be implemented to be movable in both the main scanning direction X and the sub scanning direction Y, or may be implemented to be movable only in the main scanning direction X.

The light emitting unit is not limited to a movable configuration. For example, the light emitting unit may be fixed at a position which is visually recognized by the user when the document cover 15 is in the open state. In this case, the predetermined position at which the light emitting unit is fixed may be a position in the housing 13 of the document table 12.

The predetermined position where the light emitting unit is turned on is not limited to the position (document placement position) indicating the placement position where the document M1 is to be placed. The turning-on of the light emitting unit may guide a position other than the document placement position, or may guide or notify the state of the image reading apparatus 11. In these cases, the control unit 50 may display, on the display unit 41, guidance information guided by the turning-on of the light emitting unit 18 or notification information notified by the turning-on of the light emitting unit 18 as a message. The information other than the information indicating the placement position may be mode notification information for notifying a mode in execution such as a book scan mode, state notification information for notifying a waiting state of the image reading apparatus 11 such as a document placement waiting state or a document removal waiting state, or operation guidance information for guiding an operation to be performed by the user in the waiting state. In these cases, the predetermined position may be a position on the placement surface 12A that can be visually recognized by the user when it is not particularly necessary to indicate the position.

The light emission of the light emitting unit may be scattered light or laser light.

The turning-on of the light emitting unit at the predetermined position may be visually recognized by the user through the placement surface 12A. A configuration in which the user can directly visually recognize the turning-on of the light emitting unit may be adopted, or a configuration in which the user visually recognizes reflected light obtained by reflecting light from the light emitting unit by a reflection member such as a mirror may be adopted. In this case, the light emitting unit itself may not be directly visually recognized by the user.

The light emitting unit is not limited to the configuration of illuminating a reading target from the opposite side from the placement surface 12A. The light emitting unit may be turned on at a position corresponding to a predetermined position on the same side as the placement surface 12A. For example, the light emitting unit may be implemented to guide the placement position to the user by illuminating a predetermined position of the placement surface 12A from the same side as the placement surface 12A. In this case, the user may directly visually recognize the turning-on of the light emitting unit, or may visually recognize the reflected light of the light emitted from the light emitting unit and reflected by the reflection member. In the case of the configuration in which the reflected light is visually recognized, a configuration in which the user visually recognizes the reflected light reflected by the reflection member in the housing 13 through the transparent plate 14 after the light due to the turning-on of the light emitting unit located on a placement surface 12A side (outside) passes through the transparent plate 14 may be adopted. For example, the light emitting unit may be turned on at a predetermined position in the sub scanning direction Y along the side on the back side (−X side) of the document reading region SA. With the turning-on, the predetermined position of the placement surface 12A (document reading region SA) may be guided as the placement position.

When the light source 18A of the light emitting unit 18 includes three light sources that can emit light in three colors, that is, RGB, the control unit 50 may select at least one of the three light sources to emit light, thereby turning on the light emitting unit 18 in a light color that corresponds to the state of the image reading apparatus 11. For example, the book scan mode may be indicated by turning on in a first color, the document placement waiting state may be indicated by turning on in a second color different from the first color, and a document removal state may be indicated by turning on in a third color different from the first color and the second color. The configuration indicating different states and positions depending on the difference in light colors may be similarly applied to the above-described modification using a light emitting unit other than the light emitting unit 18.

The job start button 71 is not limited to the GUI displayed on the display units 41 and 210, and may be a mechanical switch. For example, the image reading apparatus 11 may include a job start button for starting a job as the mechanical switch. The mechanical switch is not limited to the dedicated job start button. For example, after the book scan mode is selected, a predetermined mechanical switch may function as the job start button. In this case, not only the image reading apparatus 11 but also a specific key switch constituting the input unit 220 of the host apparatus 200 after the book scan mode is selected may function as the job start button.

In the embodiment, only one of the automatic mode and the manual mode constituting the book scan mode may be provided. For example, only the automatic mode may be provided, or only the manual mode may be provided.

The job start button 71 may be omitted. For example, the book scan mode may be only the automatic mode, and the job start instruction in the automatic mode of the book scan mode may be performed based on the pressing of the mode selection button 70. For example, the book scan mode may be only the manual mode, and the job start instruction for each page in the manual mode of the book scan mode may be performed based on the pressing of the mode selection button 70.

The guidance information displayed on the display unit 41 in the document waiting state by the control unit 50 may be guidance information indicating that a turning-on position (including a blinking position) of the light emitting unit 18 on the placement surface 12A of the document table 12 is the placement position where the document is to be placed. For example, the guidance screen D5 illustrated in FIG. 11 may include guidance information such as “Please the place document at the blinking position of the reading unit”.

The guidance information that the control unit 50 causes the display unit 41 to display in the document waiting state may be guidance information indicating that the book scan mode is continuing when the light emitting unit 18 is in the turn-on state (including a blinking state). For example, the guidance screen D5 illustrated in FIG. 11 may include guidance information such as “Book scan mode is being continued while reading unit is blinking”.

The mode selection button 70 for selecting the book scan mode and the job start button 71 are not limited to being provided on the same selection screen D1, and may be provided on different guidance screens. For example, when the book scan mode is selected on the first guidance screen, the control unit 50 switches a display content of the display unit 41 from a first guidance screen to a second guidance screen. The second guidance screen may include guidance information prompting the user to press the job start button 71 and guidance information prompting the user to open the document cover 15. These two pieces of guidance information may be displayed on separate guidance screens. When these two pieces of guidance information are displayed on separate guidance screens, either of them may be displayed first.

Before the document reading process (scanning), a preliminary reading process (pre-scanning) of the document M1 may be performed. In this case, when the control unit 50 detects that the document M1 is placed on the placement surface 12A by the document detection process, the control unit 50 may execute the preliminary reading process (pre-scanning). The purpose of the preliminary reading process may be detection of a document size or may be image confirmation (preview) in which the user confirms the document image in advance. In the case of image confirmation, the image of the document read in the preliminary reading process may be previewed on the display unit 210 of the host apparatus 200. In this case, only the first page in the book scan mode may be previewed, or all pages may be previewed. The control unit 50 may be implemented to execute the document reading process when the user who confirms a preview screen by the preliminary reading process presses the OK button. An image density change and a resolution change may be performed on the preview screen displayed on the display unit 210 of the host apparatus 200.

The image reading apparatus 11 may not include the book scan mode, and may include only a manual mode in which the user operates a button for instructing the start of reading for each reading.

The image reading apparatus 11 may not have a detection function of detecting the document M1. That is, the turning-on (including blinking) of the light emitting unit 18 may not serve as the turning-on for document detection.

The image reading apparatus 11 may not have a detection function of detecting the document M1. The control unit 50 may be implemented to cause the reading unit 17 to execute the document reading process of causing the reading unit 17 to read a document based on the fact that a predetermined time elapses from a time point when two conditions that the document cover 15 is in the open state and that the start of the reading job instructed by the user is instructed for each reading are satisfied.

The reading unit 17 is not limited to the CIS type and may adopt a charge coupled device (CCD) type (a reduction optical type).

An opening and closing movement of the document cover 15 with respect to the document table 12 is not limited to the configuration of only a pivot movement. The opening and closing movement of the document cover 15 may include, for example, a pivot movement and a linear movement. For example, the opening and closing movement of the document cover 15 may include an upward movement in which the document cover 15 is moved upward while maintaining a predetermined posture, or a horizontal sliding movement in which the document cover 15 moves horizontally in the X direction.

The document M1 read in the open state of the document cover 15 is not limited to the book B1 or the booklet, and may be a document printed on a sheet such as a single sheet. In this case, the document M1 as a single sheet may have a size larger or smaller than the size of the placement surface 12A. The single sheet document M1 may be placed with a part thereof protruding from the placement surface 12A or may be placed without protruding. Further, the document M1 may be a three-dimensional object other than the book B1. In addition, various documents that are preferably read in the open state of the document cover 15 or a document that is desired to be read in the open state of the document cover 15 due to circumstances of a user may be used.

The image reading apparatus 11 may include a speaker that announces the guidance information by voice in addition to the configuration of displaying the guidance information on the display units 41 and 210.

A part or all of the control unit 50 may be implemented by hardware using an electronic circuit such as an application specific integrated circuit (ASIC) or a field-Programmable gate array (FPGA), or may be implemented by only software.

The image reading apparatus 11 may not include the automatic document feeder 24. That is, the image reading apparatus 11 may be a flatbed image reading apparatus not including an ADF image reading function.

The image reading apparatus 11 may have a configuration in which the document table 12 having the placement surface 12A on which the document M1 can be placed, the reading unit 17, and the light emitting unit 18 are relatively movable in the sub scanning direction Y. For example, the image reading apparatus 11 may be implemented to read the document M1 placed on the placement surface 12A of the document table 12 by relatively moving the document table 12 in the sub scanning direction Y with respect to the upper surface opening of the housing 13 incorporating the reading unit 17 and the light emitting unit 18 in a state of being fixed at a predetermined position.

The image reading apparatus 11 may be a single scanner or a part of a multifunction peripheral. When the image reading apparatus 11 is a part of a multifunction peripheral, the image reading apparatus 11 may be mounted on an upper part of a printing apparatus. This type of multifunction peripheral may be a small multifunction peripheral for personal or household consumers or a large multifunction peripheral for business or office use.

The expression “at least one” used in the present specification means “one or more” of desired options. For example, the expression “at least one” used in the present specification means “only one choice” or “both of two choices” when the number of choices is two. As another example, the expression “at least one” used in the present specification means “just one choice” or “a combination of any two or more any choices” when the number of the choices is three or more.

### Technical Ideas

As below, the technical ideas grasped from the above described embodiment and the modified examples will be described together with effects.

[1] An image reading apparatus includes: a document table having a document table having a placement surface on which a document is to be placed; a document cover configured to open and close the placement surface of the document table; a reading unit configured to read a document placed on the placement surface of the document table on an opposite side from the placement surface; a light emitting unit configured to be switchable between turning-on and turning-off; and a control unit, in which when reading of a document is performed in an open state in which the document cover is opened with respect to the document table, the control unit turns on the light emitting unit at a predetermined position of the placement surface of the document table before the document is placed on the placement surface of the document table in the open state.

According to the configuration, by turning on the light emitting unit at a predetermined position of the placement surface before the document is placed on the document table, it is possible to guide or notify the user of information necessary for reading the document from now on. Therefore, convenience for the user can be improved. The necessary information includes information indicating that the image reading apparatus is in an appropriate document reading mode, information indicating that the image reading apparatus is in a predetermined state, and information indicating a position to be guided or notified to the user by a predetermined position to be turned on. The predetermined state of the image reading apparatus includes a waiting state in which the image reading apparatus waits for a predetermined operation by the user, a standby state until the start of document reading, and the like. The information on the position to be guided or notified to the user includes a document placement position where the user is to place the document, a document detection position where the placement of the document can be detected, a document placement position where reading of the document can be started, and the like.

[2] In the image reading apparatus according to [1], the light emitting unit may be turned on to indicate a placement position on the placement surface of the document table, the placement position being a position where the document is to be placed. According to the configuration, since the position where the document is placed on the document table can be indicated by turning on the light emitting unit, it is possible to guide the user to the position where the document is placed. The convenience for the user can be improved.

[3] In the image reading apparatus according to [1]or [2], the document table may have translucency, and the light emitting unit may be provided on an opposite side from the placement surface of the document table and is configured to emit light from the opposite side of the document table to outside the placement surface. According to the configuration, since the light is emitted from the opposite side of the placement surface of the document table, the user can easily visually recognize the emitted light through the placement surface on which the document is to be placed. For example, the placement position on the placement surface can be appropriately indicated to the user by light emission.

[4] In the image reading apparatus according to any one of [1] to [3], the light emitting unit may illuminate a document by being turned on when the reading unit performs reading of the document. According to the configuration, the position where the document is placed can be indicated by the light emitting unit, and the document can be illuminated when the reading unit reads the document by the light emitting unit.

[5] In the image reading apparatus according to and [3] or [4] cited from [2], the control unit may cause the light emitting unit to blink to indicate the placement position. According to the configuration, it is easy for the user to recognize the placement position.

[6] In the image reading apparatus according to [5], the control unit may detect that a document is placed on the placement surface based on a reading result obtained when the reading unit is caused to perform reading while the light emitting unit is turned on during blinking. According to the configuration, it is possible to detect that the document is placed on the placement surface based on the reading result obtained by the reading unit.

[7] In the image reading apparatus according to any one of [1] to [6], the control unit may execute a document reading process of causing the reading unit to read a document based on detection that the document is placed on the placement surface. According to the configuration, since the reading by the reading unit can be started based on the detection of the placement of the document, the convenience for the user is improved.

[8] The image reading apparatus according to any one of [1] to [7] may further include: a display unit configured to display information, in which the control unit causes the display unit to display guidance information for guiding placement of a document at a position indicated by turning-on of the light emitting unit. According to the configuration, it is easier to guide the user to place the document by the guidance information displayed on the display unit.

[9] In the image reading apparatus according to any one of [1] to [8], the reading unit and the light emitting unit may be integrated. According to the configuration, since the reading unit and the light emitting unit are integrated, it is not necessary to provide a movement mechanism dedicated to the light emitting unit separately from the movement mechanism for the reading unit. For example, a configuration in which a placement position of a document is indicated by turning-on can be easily implemented.

[10] An image reading apparatus includes: a document table having a placement surface on which a document is to be placed; a document cover configured to open and close the placement surface with respect to the document table; a reading unit configured to read a document placed on the placement surface of the document table on an opposite side from the placement surface; and a control unit, in which in a mode in which reading of a document is performed in an open state in which the document cover is opened with respect to the document table, the control unit executes a document reading process of causing the reading unit to read the document based on an elapse of a predetermined time from a time point when a start of a reading job is instructed by a user, the document cover is in the open state, and the document is placed on the document table.

According to the configuration, in a mode in which reading of a document is performed in the open state of the document cover, one of the start conditions of the reading process is that the start of the reading job is instructed by a user. Since the user can recognize that the reading job is started, the convenience for the user can be improved.

[11] In the image reading apparatus according to any one of [1] to [10], the reading unit may be configured with a contact image sensor. According to the configuration, since the reading unit is a contact image sensor having a smaller depth of field than a charge coupled device (CCD) image sensor, the user needs to firmly press the book so that the entire page of a book to be read can be brought close to the placement surface. When the user is forced to perform other operations, or when the user removes the line of sight from a document such as a book in order to confirm a display screen, the user's awareness of the document such as the book will decrease. Then, the document such as the book pressed by the user in an aligned state is likely to be displaced or lifted. However, according to the configuration, since the reading of the document such as the book is automatically started, the user can concentrate on the operation of pressing the document such as the book in the aligned state. Therefore, when the reading of the document such as the book is started, the document such as the book is unlikely to be displaced or lifted. Therefore, even with a contact image sensor having a relatively narrow depth of field, it is possible to read an image of a document such as a book with little displacement and little blur.

[12] The image reading apparatus according to any one of [1] to [11] may further include: an opening and closing sensor configured to detect opening and closing of the document cover; and a job start button configured to receive a start instruction of a reading job of a document, in which the control unit receives an instruction to start a reading job via the job start button, detects the open state by the opening and closing sensor, and executes a document reading process after a predetermined time elapses since the control unit detects that a document is placed on the document table based on a reading result obtained by the reading unit.

According to the configuration, after the user instructs the start of the reading job via the job start button, there is a predetermined time until the reading is started after the user places the document on the placement surface of the document table in the open state. Therefore, the user can position the document on the placement surface.

[13] A display control method for an image reading apparatus including a document table having a placement surface on which a document is to be placed, a document cover configured to open and close the placement surface with respect to the document table, a reading unit configured to read a document placed on the placement surface of the document table on an opposite side from the placement surface, and a display unit configured to display information, the display control method of the image reading apparatus includes: when an instruction is given to perform reading of the document in an open state in which the document cover is opened with respect to the document table, displaying, by the display unit, guidance information for guiding a placement position on the placement surface of the document table, the placement position being a position on which the document is to be placed. According to the method, it is possible to guide the placement position at which the document is placed on the placement surface of the document table by the guidance information displayed on the display unit to the user who instructs the performing of the reading of the document under the open state of the document cover. Therefore, convenience for the user can be improved.

What is claimed is:

1. An image reading apparatus comprising:
a document table having a placement surface on which a document is to be placed;
a document cover configured to open and close the placement surface of the document table;
a reading unit configured to read a document placed on the placement surface of the document table on an opposite side from the placement surface;
a light emitting unit configured to be switchable between turning-on and turning-off; and
a control unit, wherein
when reading of a document is performed in an open state in which the document cover is opened with respect to the document table, the control unit turns on the light emitting unit at a predetermined position of the placement surface of the document table before the document is placed on the placement surface of the document table in the open state.

2. The image reading apparatus according to claim 1, wherein
the light emitting unit is turned on to indicate a placement position on the placement surface of the document table, the placement position being a position where the document is to be placed.

3. The image reading apparatus according to claim 1, wherein
the document table has translucency, and
the light emitting unit is provided on an opposite side from the placement surface of the document table and is configured to emit light from the opposite side of the document table to outside the placement surface.

4. The image reading apparatus according to claim 2, wherein
the light emitting unit illuminates a document by being turned on when the reading unit performs reading of the document.

5. The image reading apparatus according to claim 2, wherein
the control unit causes the light emitting unit to blink to indicate the placement position.

6. The image reading apparatus according to claim 5, wherein
the control unit detects that a document is placed on the placement surface based on a reading result obtained when the reading unit is caused to perform reading while the light emitting unit is turned on during blinking.

7. The image reading apparatus according to claim 5, wherein
the control unit executes a document reading process of causing the reading unit to read a document based on detection that the document is placed on the placement surface.

8. The image reading apparatus according to claim 1, further comprising:
a display unit configured to display information, wherein
the control unit causes the display unit to display guidance information for guiding placement of a document at a position indicated by turning-on of the light emitting unit.

9. The image reading apparatus according to claim 3, wherein
the reading unit and the light emitting unit are integrated.

10. An image reading apparatus comprising:
a document table having a placement surface on which a document is to be placed;
a document cover configured to open and close the placement surface with respect to the document table;
a reading unit configured to read a document placed on the placement surface of the document table on an opposite side from the placement surface; and
a control unit, wherein
in a mode in which reading of a document is performed in an open state in which the document cover is opened with respect to the document table, the control unit executes a document reading process of causing the reading unit to read the document based on an elapse of a predetermined time from a time point when a start of a reading job is instructed by a user, the document cover is in the open state, and the document is placed on the document table.

11. The image reading apparatus according to claim 1, wherein
the reading unit constitutes a contact image sensor.

12. The image reading apparatus according to claim 1, further comprising:
an opening and closing sensor configured to detect opening and closing of the document cover; and
a job start button configured to receive a start instruction of a reading job of a document, wherein the control unit receives an instruction to start a reading job via the job start button, detects the open state by the opening and closing sensor, and executes a document reading process after a predetermined time elapses since the control unit detects that a document is placed on the document table based on a reading result obtained by the reading unit.

13. A display control method for an image reading apparatus including a document table having a placement surface on which a document is to be placed, a document cover configured to open and close the placement surface with respect to the document table, a reading unit configured to read a document placed on the placement surface of the document table on an opposite side from the placement surface, and a display unit configured to display information, the display control method of the image reading apparatus comprising:
when an instruction is given to perform reading of the document in an open state in which the document cover is opened with respect to the document table, displaying, by the display unit, guidance information for guiding a placement position on the placement surface of the document table, the placement position being a position on which the document is to be placed.
